(19) United States
(12) Patent Application Publication
(10) Pub. No.: US 2022/0290344 A1
(43) Pub. Date: Sep. 15, 2022

(54) LOW-DUST AIRLAID NONWOVEN MATERIALS

(71) Applicant: GLATFELTER CORPORATION, Charlotte, NC (US)

(72) Inventors: Jacek K. DUTKIEWICZ, Cordova, TN (US); Ronald T. MOOSE, Lakeland, TN (US); Brian FONG, Lakeland, TN (US); Kathy MCGEE, Marion, AK (US); Richard BOOKER, Arlington, TN (US); Alan J. BELL, Germantown, TN (US)

(21) Appl. No.: 17/633,904

(22) PCT Filed: Aug. 5, 2020
(86) PCT No.: PCT/IB2020/057401

§ 371 Date: Feb. 8, 2022

Related U.S. Application Data
(60) Provisional application No. 62/884,258, filed on Aug. 8, 2019.

(51) Int. Cl. D04H 1/26; D04H 1/732; D04H 1/28; B32B 5/26; B32B 5/02

(52) U.S. Cl. CPC D04H 1/26; D04H 1/732; D04H 1/28; B32B 5/266; B32B 5/022; B32B 2262/067; B32B 2260/046; B32B 2260/021; B32B 2262/04; B32B 2262/124; B32B 2255/02; B32B 2255/26

(57) ABSTRACT

Nonwoven materials having low dust or lint content and methods of making the same are provided. Such nonwoven materials can include cellulose fibers pre-treated with a plasticizer or include the addition of plasticizer during the process of forming the material.

### 1. FIELD

The presently disclosed subject matter relates to nonwoven materials and methods of making the same. Such nonwoven materials advantageously have a reduced dust or lint content.

### 2. BACKGROUND

Conventional airlaid nonwoven materials have a reputation for being dusty. Dustiness of such materials can be attributed, in part, to the presence of unbound short cellulosic fibers. The dust, also referred to as lint, can have a negative impact on the processability of the airlaid materials in various converting processes and can also limit the application of these types of nonwovens, for example, in medical environments.

There has been a constant demand to provide airlaid nonwoven materials with low dust or lint content. One method to achieve such low-dust airlaid nonwoven materials is to apply more binder to the surface of the material. Another method includes the addition of more bicomponent fibers to the structure. An even costlier alternative is to increase both the addition of binder to the surface and bicomponent fiber content of the material.

Thus, there remains a need for practical and cost effective methods to reduce the dust content of airlaid nonwoven materials. There further remains a need for improved low-dust airlaid nonwoven materials having increased processability and which also can be used in a variety of applications. The disclosed subject matter addresses these and other needs.

### 3. SUMMARY OF THE INVENTION

The presently disclosed subject matter provides for improved nonwoven materials which advantageously have reduced dust or lint content. Such nonwoven materials can include cellulose fibers pre-treated with plasticizer (e.g., polyethylene glycol or PEG) or alternatively, can include the application of plasticizer during the nonwoven forming process.

The present disclosure provides airlaid nonwoven materials. The nonwoven materials can include a first layer comprising cellulose fibers treated with a plasticizer. Such nonwoven materials can have a dust content of less than about 10%.

In certain embodiments, the plasticizer can include polyethylene glycol. In particular embodiments, the plasticizer can include polyethylene glycol 400.

In certain embodiments, the first layer can further include a binder.

In certain embodiments, the airlaid nonwoven material can further include a second layer adjacent to the first layer. In certain embodiments, the second layer can include bicomponent fibers.

In certain embodiments, the nonwoven material can have an absorptive capacity of at least about 6 g/g.

In certain embodiments, the nonwoven material can have an absorbency rate of less than about 10 seconds.

In certain embodiments, the nonwoven material can have a Gelbo sum value of less than about 50000.

The present disclosure provides multi-layer airlaid nonwoven materials. The nonwoven materials can include a first layer, a second layer, and a third layer. The first layer can include a first plasticizer. The second layer can be adjacent to the first layer and can include cellulose fibers. The third layer can be adjacent to the second layer and can include a second plasticizer. The nonwoven material can have a dust content of less than about 10%.

In certain embodiments, the first and third layers can further include a binder.

In certain embodiments, the first and second plasticizers can include polyethylene glycol. In particular embodiments, the first and second plasticizers can include polyethylene glycol 400.

The present disclosure provides multi-layer airlaid nonwoven materials. The nonwoven materials can include a first layer and a second layer. The first layer can include a plasticizer. The second layer can be adjacent to the first layer and can include cellulose fibers and a binder. The nonwoven material can have a dust content of less than about 10%.

In certain embodiments, the nonwoven material can further include a third layer adjacent to the second layer and comprising a plasticizer.

In certain embodiments the plasticizer of the first and third layers can include polyethylene glycol.

In certain embodiments, the plasticizer is present in an amount of from about 1% to about 2%, based on the total weight of the nonwoven material.

The foregoing has outlined broadly the features and technical advantages of the present application in order that the detailed description that follows may be better understood.

Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 4. BRIEF DESCRIPTION OF THE DRAWINGS

FIG. 1 depicts the dust testing results of low-dust latex-bonded airlaid (LBAL) nonwoven materials (Structures 1A-1B) prepared in accordance with certain non-limiting embodiments as provided in Example 1; and

FIG. 2 depicts the dust testing results of low-dust thermally-bonded airlaid (TBAL) nonwoven materials (Structures 2A-2B) prepared in accordance with certain non-limiting embodiments as provided in Example 2.

### 5. DETAILED DESCRIPTION

The presently disclosed subject matter provides novel nonwoven materials having a low dust or lint content and methods of making the same. Nonwoven materials of the present disclosure include cellulosic fibers treated with a plasticizer (e.g., polyethylene glycol) prior to forming a web structure including the treated fibers or by applying the plasticizer on the fiber web during the nonwoven forming process which surprisingly and advantageously provided airlaid nonwoven materials with low dust or lint content. These and other aspects of the disclosed subject matter are discussed more in the detailed description and Examples.

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value.

The term “basis weight” as used herein refers to the quantity by weight of a compound over a given area. Examples of the units of measure include grams per square meter as identified by the acronym “gsm”.

As used herein, the term “cellulose” or “cellulosic” includes any material having cellulose as a major constituent, and specifically, comprising at least 50 percent by weight cellulose or a cellulose derivative. Thus, the term includes cotton, typical wood pulps, cellulose acetate, rayon, thermochemical wood pulp, chemical wood pulp, debonded chemical wood pulp, milkweed floss, microcrystalline cellulose, microfibrillated cellulose, and the like.

As used herein, the phrase “chemically modified,” when used in reference to a fiber, means that the fiber has been treated with a polyvalent metal-containing compound to produce a fiber with a polyvalent metal-containing compound bound to it. It is not necessary that the compound chemically bond with the fibers, although it is preferred that the compound remain associated in close proximity with the fibers, by coating, adhering, precipitation, or any other mechanism such that it is not dislodged from the fibers during normal handling of the fibers. In particular, the compound can remain associated with the fibers even when wetted or washed with a liquid. For convenience, the association between the fiber and the compound may be referred to as the bond, and the compound may be said to be bound to the fiber.

As used herein, the term “dust” or “dusty” refers to particles of matter or materials including such parties, which can include fine particles.

As used herein, the term “fiber” or “fibrous” refers to a particulate material wherein the length to diameter ratio of such particulate material is greater than about 10. Conversely, a “nonfiber” or “nonfibrous” material is meant to refer to a particulate material wherein the length to diameter ratio of such particulate matter is about 10 or less.

As used herein, the term “lint” refers to dust or short, fine fibers that separate from the surface of a material, especially during processing.

As used herein, a “nonwoven” refers to a class of material, including but not limited to textiles or plastics. Nonwovens are sheet or web structures made of fiber, filaments, molten plastic, or plastic films bonded together mechanically, thermally, or chemically. A nonwoven is a fabric made directly from a web of fiber, without the yarn preparation necessary for weaving or knitting. In a nonwoven, the assembly of fibers is held together by one or more of the following: (1) by mechanical interlocking in a random web or mat; (2) by fusing of the fibers, as in the case of thermoplastic fibers; or (3) by bonding with a cementing medium such as a natural or synthetic resin.

As used herein, the term “weight percent” is meant to refer to either (i) the quantity by weight of a constituent/component in the material as a percentage of the weight of a layer of the material; or (ii) to the quantity by weight of a constituent/component in the material as a percentage of the weight of the final nonwoven material or product.

### Fibers

Nonwoven materials of the presently disclosed subject matter comprise fibers. The fibers can be natural, synthetic, or a mixture thereof. In certain embodiments, the fibers can be cellulose-based fibers, one or more synthetic fibers, or a mixture thereof. In particular embodiments, the cellulose fibers can be pre-treated with one or more plasticizers (e.g., polyethylene glycol).

### Cellulose Fibers

Any cellulose fibers known in the art, including cellulose fibers of any natural origin, such as those derived from wood pulp or regenerated cellulose, can be used in a cellulosic layer. In certain embodiment, cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. In other embodiments, cellulose fibers include, but are not limited to, kraft digested fibers, including prehydrolyzed kraft digested fibers. Non-limiting examples of cellulose fibers suitable for use in this subject matter are the cellulose fibers derived from softwoods, such as pines, firs, and spruces. Other suitable cellulose fibers include, but are not limited to, those derived from Esparto grass, bagasse, kemp, flax, hemp, kenaf, and other lignaceous and cellulosic fiber sources. Suitable cellulose fibers include, but are not limited to, bleached Kraft southern pine fibers sold under the trademark FOLEY FLUFFS® (Buckeye Technologies Inc., Memphis, Tenn.). Additionally, fibers sold under the trademark CELLU TISSUE® (e.g., Grade 3024) (Clearwater Paper Corporation, Spokane, Wash.) are utilized in certain aspects of the disclosed subject matter.

The nonwoven materials of the disclosed subject matter can also include, but are not limited to, a commercially available bright fluff pulp including, but not limited to, southern softwood kraft (such as Golden Isles® 4725 from GP Cellulose) or southern softwood fluff pulp (such as Treated FOLEY FLUFFS®) northern softwood sulfite pulp (such as T 730 from Weyerhaeuser), or hardwood pulp (such as Eucalyptus). In certain embodiments, the nonwoven materials can include Eucalyptus fibers (Suzano, untreated). While certain pulps may be preferred based on a variety of factors, any absorbent fluff pulp or mixtures thereof can be used. In certain embodiments, wood cellulose, cotton linter pulp, chemically modified cellulose such as crosslinked cellulose fibers and highly purified cellulose fibers can be used. Non-limiting examples of additional pulps are FOLEY FLUFFS® FFTAS (also known as FFTAS or Buckeye Technologies FFT-AS pulp), and Weyco CF401.

In certain embodiments, fine fibers, such as certain softwood fibers can be used. Certain non-limiting examples of such fine fibers, with pulp fiber coarseness properties are provided in Table I below with reference to Watson, P., et al., Canadian Pulp Fibre Morphology: Superiority and Considerations for End Use Potential, The Forestry Chronicle, Vol. 85 No. 3, 401-408 May/June 2009.

TABLE I
Softwood Fibers

| | Pulp Fiber |
|---|---|
| Species | Coarseness (mg/100 m) |
| Coastal Douglas-fir | 24 |
| Western hemlock | 20 |
| Spruce/pine | 18 |
| Western redcedar | 16 |
| Southern pine | 30 |
| Radiata pine | 22 |
| Scandinavian pine | 20 |
| Black spruce | 18 |

In certain embodiments, fine fibers, such as certain hardwood fibers can be used. Certain non-limiting examples of such fine fibers, with pulp fiber coarseness properties are provided in Table II with reference, at least in part, to Horn, R., Morphology of Pulp Fiber from Hardwoods and Influence on Paper Strength, Research Paper FPL 312, Forest Products Laboratory, U.S. Department of Agriculture (1978) and Bleached Eucalyptus Kraft Pulp ECF Technical Sheet (April 2017) (available at: https://www.metsafibre.com/en/Documents/Data-sheets/Cenibra-euca-Eucalyptus.pdf). In particular embodiments, Eucalyptus pulp (Sunzano, untreated) can be used.

TABLE II
Hardwood fibers

| | Pulp Fiber |
|---|---|
| | Coarseness |
| Species | (mg/100 m) |
| Red alder | 12.38 |
| Aspen | 8.59 |
| American elm | 9.53 |
| Paper birch | 13.08 |
| American beech | 13.10 |
| Shagbark hickory | 10.59 |
| Sugar maple | 7.86 |
| White oak | 14.08 |
| Eucalyptus | 6.5 +/− 2.3 |

Other suitable types of cellulose fiber include, but are not limited to, chemically modified cellulose fibers. In particular embodiments, the modified cellulose fibers are crosslinked cellulose fibers. U.S. Pat. Nos. 5,492,759, 5,601,921, and 6,159,335, all of which are hereby incorporated by reference in their entireties, relate to chemically treated cellulose fibers useful in the practice of this disclosed subject matter. In certain embodiments, the modified cellulose fibers comprise a polyhydroxy compound. Non-limiting examples of polyhydroxy compounds include glycerol, trimethylolpropane, pentaerythritol, polyvinyl alcohol, partially hydrolyzed polyvinyl acetate, and fully hydrolyzed polyvinyl acetate. In certain embodiments, the fiber is treated with a polyvalent cation-containing compound. In one embodiment, the polyvalent cation-containing compound is present in an amount from about 0.1 weight percent to about 20 weight percent based on the dry weight of the untreated fiber. In particular embodiments, the polyvalent cation containing compound is a polyvalent metal ion salt. In certain embodiments, the polyvalent cation containing compound is selected from the group consisting of aluminum, iron, tin, salts thereof, and mixtures thereof. Any polyvalent metal salt including transition metal salts may be used. Non-limiting examples of suitable polyvalent metals include beryllium, magnesium, calcium, strontium, barium, titanium, zirconium, vanadium, chromium, molybdenum, tungsten, manganese, iron, cobalt, nickel, copper, zinc, aluminum and tin. Preferred ions include aluminum, iron and tin. The preferred metal ions have oxidation states of +3 or +4. Any salt containing the polyvalent metal ion may be employed. Non-limiting examples of suitable inorganic salts of the above metals include chlorides, nitrates, sulfates, borates, bromides, iodides, fluorides, nitrides, perchlorates, phosphates, hydroxides, sulfides, carbonates, bicarbonates, oxides, alkoxides phenoxides, phosphites, and hypophosphites. Non-limiting examples of suitable organic salts of the above metals include formates, acetates, butyrates, hexanoates, adipates, citrates, lactates, oxalates, propionates, salicylates, glycinates, tartrates, glycolates, sulfonates, phosphonates, glutamates, octanoates, benzoates, gluconates, maleates, succinates, and 4,5-dihydroxy-benzene-1,3-disulfonates. In addition to the polyvalent metal salts, other compounds such as complexes of the above salts include, but are not limited to, amines, ethylenediaminetetra-acetic acid (EDTA), diethylenetriaminepenta-acetic acid (DIPA), nitrilotri-acetic acid (NTA), 2,4-pentanedione, and ammonia may be used.

In one embodiment, the cellulose pulp fibers are chemically modified cellulose pulp fibers that have been softened or plasticized to be inherently more compressible than unmodified pulp fibers. The same pressure applied to a plasticized pulp web will result in higher density than when applied to an unmodified pulp web. Additionally, the densified web of plasticized cellulose fibers is inherently softer than a similar density web of unmodified fiber of the same wood type. Softwood pulps may be made more compressible using cationic surfactants as debonders to disrupt interfiber associations. Use of one or more debonders facilitates the disintegration of the pulp sheet into fluff in the airlaid process. Examples of debonders include, but are not limited to, those disclosed in U.S. Pat. Nos. 4,432,833, 4,425,186 and 5,776,308, all of which are hereby incorporated by reference in their entireties. One example of a debonder-treated cellulose pulp is FFLE+. Plasticizers for cellulose, which can be added to a pulp slurry prior to forming wetlaid sheets, can also be used to soften pulp, although they act by a different mechanism than debonding agents. Plasticizing agents act within the fiber, at the cellulose molecule, to make flexible or soften amorphous regions. The resulting fibers are characterized as limp. Since the plasticized fibers lack stiffness, the comminuted pulp is easier to densify compared to fibers not treated with plasticizers. Plasticizers include, but are not limited to, polyhydric alcohols such as glycerol, low molecular weight polyglycol such as polyethylene glycols, polyhydroxy compounds, sorbitol, ethylene glycol, and ethanolamine. These and other plasticizers are described and exemplified in U.S. Pat. Nos. 4,098,996, 5,547,541 and 4,731,269, all of which are hereby incorporated by reference in their entireties. For example and not limitation, the plasticizer can be polyethylene glycol 100 (PEG 100, polyethylene glycol 200 (PEG 200), polyethylene glycol 300 (PEG 300), polyethylene glycol 400 (PEG 400), polyethylene glycol 600 (PEG 600), or polyethylene glycol 1000 (PEG 1000). Ammonia, urea, and alkylamines are also known to plasticize wood products, which mainly contain cellulose (A. J. Stamm, Forest Products Journal 5(6):413, 1955, hereby incorporated by reference in its entirety).

In particular embodiments, nonwoven materials of the present disclosure can include cellulose fibers pre-treated with plasticizer such as polyethylene glycol, for example, Carbowax Sentry Polyethylene Glycol 400 NF (from The Dow Chemical Company). The plasticizer can be diluted into a solution, for example, at about 1% to about 2%, and sprayed onto the cellulose fibers. In particular embodiments, the total plasticizer add-on to the cellulose fibers can be from about 0.01% of about 10%, from about 0.1% to about 10%, from about 1% to about 5%, from about 2% to about 4%, or from about 1% to about 3%, based on the ambient pulp sheet weight. In particular embodiments, the total plasticizer add-on to the cellulose fibers can be about 0.01%, about 0.1%, about 1%, about 2%, about 3%, about 4%, about 5%, about 6%, about 7%, about 8%, about 9%, or about 10% based on the ambient pulp sheet weight.

In particular embodiments of the disclosed subject matter, the following cellulose is used:

Golden Isle 4725, semi-treated pulp (available from Georgia-Pacific); Golden Isle 4725, semi-treated pulp from Georgia Pacific, Leaf River (treated with 1% Carbowax Sentry Polyethylene Glycol 400 NF); Eucafluff (available from Suzano Pulp); Paper S. A. Eucafluff (bleached Euculyptus Kraft fluff pulp available from Suzano Pulp). Nonwoven materials of the present disclosure can include cellulose fibers. In certain embodiments, one or more layers of the nonwoven material can contain from about 50% to about 95%, from about 65% to about 95%, from about 70% or about 90%, or from about 75% to about 85% cellulose fibers. In certain embodiments, one or more layers of the nonwoven material can contain about 65%, about 75%, about 85%, or about 95% cellulose fibers.

### Synthetic Fibers

In addition to the use of cellulose fibers, the presently disclosed subject matter also contemplates the use of synthetic fibers. In one embodiment, the synthetic fibers comprise bicomponent and/or mono-component fibers. Bicomponent fibers having a core and sheath are known in the art. Many varieties are used in the manufacture of nonwoven materials, particularly those produced for use in airlaid techniques. Various bicomponent fibers suitable for use in the presently disclosed subject matter are disclosed in U.S. Pat. Nos. 5,372,885 and 5,456,982, both of which are hereby incorporated by reference in their entireties. Examples of bicomponent fiber manufacturers include, but are not limited to, Trevira (Bobingen, Germany), Fiber Innovation Technologies (Johnson City, Tenn.) and ES Fiber Visions (Athens, Ga.).

Bicomponent fibers can incorporate a variety of polymers as their core and sheath components. Bicomponent fibers that have a PE (polyethylene) or modified PE sheath typically have a PET (polyethylene terephthalate) or PP (polypropylene) core. In one embodiment, the bicomponent fiber has a core made of polyester and sheath made of polyethylene. In another embodiment, the bicomponent fiber has a core made of polypropylene and a sheath made of polyethylene.

The denier of the bicomponent fiber preferably ranges from about 1.0 dpf to about 4.0 dpf, and more preferably from about 1.5 dpf to about 2.5 dpf. The length of the bicomponent fiber can be from about 3 mm to about 36 mm, preferably from about 3 mm to about 12 mm, more preferably from about 3 mm to about 10. In particular embodiments, the length of the bicomponent fiber is from about 4 mm to about 8 mm, or about 6 mm. In a particular embodiment, the bicomponent fiber is Trevira T255 which contains a polyester core and a polyethylene sheath modified with maleic anhydride. T255 has been produced in a variety of deniers, cut lengths and core sheath configurations with preferred configurations having a denier from about 1.7 dpf to 2.0 dpf and a cut length of about 4 mm to 12 mm and a concentric core sheath configuration. In a specific embodiment, the bicomponent fiber is Trevira 1661, T255, 2.0 dpf and 6 mm in length.

Bicomponent fibers are typically fabricated commercially by melt spinning. In this procedure, each molten polymer is extruded through a die, for example, a spinneret, with subsequent pulling of the molten polymer to move it away from the face of the spinneret. This is followed by solidification of the polymer by heat transfer to a surrounding fluid medium, for example chilled air, and taking up of the now solid filament. Non-limiting examples of additional steps after melt spinning can also include hot or cold drawing, heat treating, crimping and cutting. This overall manufacturing process is generally carried out as a discontinuous two-step process that first involves spinning of the filaments and their collection into a tow that comprises numerous filaments. During the spinning step, when molten polymer is pulled away from the face of the spinneret, some drawing of the filament does occur which can also be called the draw-down. This is followed by a second step where the spun fibers are drawn or stretched to increase molecular alignment and crystallinity and to give enhanced strength and other physical properties to the individual filaments. Subsequent steps can include, but are not limited to, heat setting, crimping and cutting of the filament into fibers. The drawing or stretching step can involve drawing the core of the bicomponent fiber, the sheath of the bicomponent fiber or both the core and the sheath of the bicomponent fiber depending on the materials from which the core and sheath are comprised as well as the conditions employed during the drawing or stretching process.

Bicomponent fibers can also be formed in a continuous process where the spinning and drawing are done in a continuous process. During the fiber manufacturing process it is desirable to add various materials to the fiber after the melt spinning step at various subsequent steps in the process. These materials can be referred to as “finish” and be comprised of active agents such as, but not limited to, lubricants and anti-static agents. The finish is typically delivered via an aqueous based solution or emulsion. Finishes can provide desirable properties for both the manufacturing of the bicomponent fiber and for the user of the fiber, for example in an airlaid or wetlaid process.

Numerous other processes are involved before, during and after the spinning and drawing steps and are disclosed in U.S. Pat. Nos. 4,950,541, 5,082,899, 5,126,199, 5,372,885, 5,456,982, 5,705,565, 2,861,319, 2,931,091, 2,989,798, 3,038,235, 3,081,490, 3,117,362, 3,121,254, 3,188,689, 3,237,245, 3,249,669, 3,457,342, 3,466,703, 3,469,279, 3,500,498, 3,585,685, 3,163,170, 3,692,423, 3,716,317, 3,778,208, 3,787,162, 3,814,561, 3,963,406, 3,992,499, 4,052,146, 4,251,200, 4,350,006, 4,370,114, 4,406,850, 4,445,833, 4,717,325, 4,743,189, 5,162,074, 5,256,050, 5,505,889, 5,582,913, and 6,670,035, all of which are hereby incorporated by reference in their entireties.

The presently disclosed subject matter can also include, but are not limited to, articles that contain bicomponent fibers that are partially drawn with varying degrees of draw or stretch, highly drawn bicomponent fibers and mixtures thereof. These can include, but are not limited to, a highly drawn polyester core bicomponent fiber with a variety of sheath materials, specifically including a polyethylene sheath such as Trevira T255 (Bobingen, Germany) or a highly drawn polypropylene core bicomponent fiber with a variety of sheath materials, specifically including a polyethylene sheath such as ES FiberVisions AL-Adhesion-C (Varde, Denmark). Additionally, Trevira T265 bicomponent fiber (Bobingen, Germany), having a partially drawn core with a core made of polybutylene terephthalate (PBT) and a sheath made of polyethylene can be used. The use of both partially drawn and highly drawn bicomponent fibers in the same structure can be leveraged to meet specific physical and performance properties based on how they are incorporated into the structure.

The bicomponent fibers of the presently disclosed subject matter are not limited in scope to any specific polymers for either the core or the sheath as any partially drawn core bicomponent fiber can provide enhanced performance regarding elongation and strength. The degree to which the partially drawn bicomponent fibers are drawn is not limited in scope as different degrees of drawing will yield different enhancements in performance. The scope of the partially drawn bicomponent fibers encompasses fibers with various core sheath configurations including, but not limited to concentric, eccentric, side by side, islands in a sea, pie segments and other variations. The relative weight percentages of the core and sheath components of the total fiber can be varied. In addition, the scope of this subject matter covers the use of partially drawn homopolymers such as polyester, polypropylene, nylon, and other melt spinnable polymers. The scope of this subject matter also covers multicomponent fibers that can have more than two polymers as part of the fiber structure.

Nonwoven materials of the present disclosure can include bicomponent fibers. In certain embodiments, the nonwoven materials of the present disclosure can include high core bicomponent fibers. High core bicomponent fibers have core to sheath ratio that exceeds 1:1, i.e., the high core bicomponent fibers comprise more than 50% core by weight. In certain embodiments, the nonwoven materials of the present disclosure can include Trevira Type 255; 1.7 dtex; 6 mm; 30% PE/70% PET. In certain embodiments, one or more layers of the nonwoven material can contain from about 0% to about 35%, from about 1% to about 34%, from about 5% to about 30%, or from about 10% to about 25% bicomponent components. In particular embodiments, one or more layers of the nonwoven material can include about 0%, about 1%, about 10%, about 15%, about 20%, about 25%, about 30%, or about 25% bicomponent fibers.

In particular embodiments, the bicomponent fibers are low dtex staple bicomponent fibers in the range of about 0.5 dtex to about 20 dtex. In certain embodiments, the dtex value can range from about 1.3 dtex to about 15 dtex, about 1.5 dtex to about 10 dtex, about 1.7 dtex to about 6.7 dtex, or about 2.2 dtex to about 5.7 dtex. In certain embodiments, the dtex value can be about 1.3 dtex, about 1.5 dtex, about 1.7 dtex, about 2.2 dtex, about 3.3 dtex, about 5.7 dtex, about 6.7 dtex, or about 10 dtex.

Other synthetic fibers suitable for use in various embodiments as fibers or as bicomponent binder fibers include, but are not limited to, fibers made from various polymers including, by way of example and not by limitation, acrylic, polyamides (including, but not limited to, Nylon 6, Nylon 6/6, Nylon 12, polyaspartic acid, polyglutamic acid), polyamines, polyimides, polyacrylics (including, but not limited to, polyacrylamide, polyacrylonitrile, esters of methacrylic acid and acrylic acid), polycarbonates (including, but not limited to, polybisphenol A carbonate, polypropylene carbonate), polydienes (including, but not limited to, polybutadiene, polyisoprene, polynorbomene), polyepoxides, polyesters (including, but not limited to, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate), polyethers (including, but not limited to, polyethylene glycol (polyethylene oxide), polybutylene glycol, polypropylene oxide, polyoxymethylene (paraformaldehyde), polytetramethylene ether (polytetrahydrofuran), polyepichlorohydrin), polyfluorocarbons, formaldehyde polymers (including, but not limited to, urea-formaldehyde, melamine-formaldehyde, phenol formaldehyde), natural polymers (including, but not limited to, cellulosics, chitosans, lignins, waxes), polyolefins (including, but not limited to, polyethylene, polypropylene, polybutylene, polybutene, polyoctene), polyphenylenes (including, but not limited to, polyphenylene oxide, polyphenylene sulfide, polyphenylene ether sulfone), silicon containing polymers (including, but not limited to, polydimethyl siloxane, polycarbomethyl silane), polyurethanes, polyvinyls (including, but not limited to, polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone), polyacetals, polyarylates, and copolymers (including, but not limited to, polyethylene-co-vinyl acetate, polyethylene-co-acrylic acid, polybutylene terephthalate-co-polyethylene terephthalate, polylauryllactam-block-polytetrahydrofuran), polybutylene succinate and polylactic acid based polymers.

In specific embodiments, the synthetic fiber layer contains a high dtex staple fibers in the range of about 1.2 to about 20 dtex. In certain embodiments, the dtex value can range from about 1.2 dtex to about 15 dtex, or from about 2 dtex to about 10 dtex. In particular embodiments, the fiber can have a dtex value of about 6.7 dtex.

In other specific embodiments, the synthetic layer contains synthetic filaments. The synthetic filaments can be formed by spinning and/or extrusion processes. For example, such processes can be similar to the methods described above with reference to melt spinning processes. The synthetic filaments can include one or more continuous strands. In certain embodiments, the synthetic filaments can include polypropylene.

### Plasticizers

Nonwoven materials of the presently disclosed subject matter can further comprise one or more plasticizers. In certain embodiments, the one or more plasticizers can include polyethylene glycol. In particular embodiments, the one or more plasticizers can be applied to the nonwoven material during the forming process.

Plasticizers include, but are not limited to, polyhydric alcohols such as glycerol, low molecular weight polyglycol such as polyethylene glycols, polyhydroxy compounds, sorbitol, ethylene glycol, and ethanolamine. These and other plasticizers are described and exemplified in U.S. Pat. Nos. 4,098,996, 5,547,541 and 4,731,269, all of which are hereby incorporated by reference in their entireties. For example and not limitation, the plasticizer can be polyethylene glycol 100 (PEG 100, polyethylene glycol 200 (PEG 200), polyethylene glycol 300 (PEG 300), polyethylene glycol 400 (PEG 400), polyethylene glycol 600 (PEG 600), polyethylene glycol 1000 (PEG 1000), or higher molecular weight polyethylene glycols. Ammonia, urea, and alkylamines are also known to plasticize wood products, which mainly contain cellulose (A. J. Stamm, Forest Products Journal 5(6):413, 1955, hereby incorporated by reference in its entirety).

In certain embodiments, the plasticizer can be added as a solution. For example, and not by limitation, the plasticizer can be added to the nonwoven material in a 10% solution.

Nonwoven materials of the present disclosure can include one or more plasticizers in an amount of about 0.1 gsm to about 10 gsm, about 0.4 gsm to about 5 gsm, or about 0.5 gsm to about 1.5 gsm. In particular embodiments, the nonwoven materials can include one or more plasticizers in an amount of about 0.4 gsm, 0.52 gsm, 0.7 gsm or about 1.4 gsm. Plasticizers can be included in nonwoven materials of the present disclosure in an amount of from about 0.5% to about 5% or from about 1% to about 2% of the total structure. In particular embodiments, the nonwoven material can include plasticizers in an amount of at least about 0.8%, at least about 1%, about 1% or about 2% of the total structure. Plasticizers can be applied to one side of a fibrous layer, preferably an externally facing layer. Alternatively, plasticizer can be applied to both sides of a layer, in equal or disproportionate amounts. In certain embodiments, plasticizer can be applied to at least one outer surface of a nonwoven material.

### Binders

Suitable binders include, but are not limited to, liquid binders and powder binders. Non-limiting examples of liquid binders include emulsions, solutions, or suspensions of binders. Non-limiting examples of binders include polyethylene powders, copolymer binders, vinylacetate ethylene binders, styrene-butadiene binders, urethanes, urethane-based binders, acrylic binders, thermoplastic binders, natural polymer based binders, and mixtures thereof.

Suitable binders include, but are not limited to, copolymers, including vinyl-chloride containing copolymers such as Wacker Vinnol 4500, Vinnol 4514, and Vinnol 4530, vinylacetate ethylene (“VAE”) copolymers, which can have a stabilizer such as Wacker Vinnapas 192, Wacker Vinnapas EF 539, Wacker Vinnapas EP907, Wacker Vinnapas EP129, Celanese Duroset E130, Celanese Dur-O-Set Elite 130 25-1813 and Celanese Dur-O-Set TX-849, Celanese 75-524A, polyvinyl alcohol—polyvinyl acetate blends such as Wacker Vinac 911, vinyl acetate homopolyers, polyvinyl amines such as BASF Luredur, acrylics, cationic acrylamides, polyacryliamides such as Bercon Berstrength 5040 and Bercon Berstrength 5150, hydroxyethyl cellulose, starch such as National Starch CATO® 232, National Starch CATO® 255, National Starch Optibond, National Starch Optipro, or National Starch OptiPLUS, guar gum, styrene-butadienes, urethanes, urethane-based binders, thermoplastic binders, acrylic binders, and carboxymethyl cellulose such as Hercules Aqualon CMC. In certain embodiments, the binder is a natural polymer based binder. Non-limiting examples of natural polymer based binders include polymers derived from starch, cellulose, chitin, and other polysaccharides.

In certain embodiments, the binder is water-soluble. In one embodiment, the binder is a vinylacetate ethylene copolymer. One non-limiting example of such copolymers is EP907 (Wacker Chemicals, Munich, Germany). Vinnapas EP907 can be applied at a level of about 10% solids incorporating about 0.75% by weight Aerosol OT (Cytec Industries, West Paterson, N.J.), which is an anionic surfactant. In certain embodiments, Vinnapas 192 can be applied at a level of about 15% incorporating about 0.08% by weight Aerosol OT 75 (Cytec Industries, West Paterson, N.J.).

Other classes of liquid binders such as styrene-butadiene and acrylic binders can also be used. As described in U.S. Pat. No. 5,281,306, the contents of which are hereby incorporated by reference in their entirety, water-soluble binders including a carboxyl group can include polysaccharide derivatives, synthetic high polymers, and naturally-occurring substances. Non-limiting examples of suitable naturally-occurring water-soluble binders are alginic acid, xanthan gum, arabic gum, tragacanth gum, and pectin.

In certain embodiments, the binder is not water-soluble. Examples of these binders include, but are not limited to, Vinnapas 124 and 192 (Wacker), which can have an opacifier and whitener, including, but not limited to, titanium dioxide, dispersed in the emulsion. Other binders include, but are not limited to, Celanese Emulsions (Bridgewater, N.J.) DUR-O-SET® Elite 22 DUR-O-SET® 909, and Elite 33.

In certain embodiments, the binder is a thermoplastic binder. Such thermoplastic binders include, but are not limited to, any thermoplastic polymer which can be melted at temperatures which will not extensively damage the cellulose fibers. Preferably, the melting point of the thermoplastic binding material will be less than about 175° C. Examples of suitable thermoplastic materials include, but are not limited to, suspensions of thermoplastic binders and thermoplastic powders. In particular embodiments, the thermoplastic binding material can be, for example, polyethylene, polypropylene, polyvinylchloride, and/or polyvinylidene chloride.

The binder can be non-crosslinkable or crosslinkable. In certain embodiments, the binder is WD4047 urethane-based binder solution supplied by HB Fuller. In one embodiment, the binder is Michem Prime 4983-45N dispersion of ethylene acrylic acid (“EAA”) copolymer supplied by Michelman. In certain embodiments, the binder is Dur-O-Set Elite 22LV emulsion of VAE binder supplied by Celanese Emulsions (Bridgewater, N.J.). As noted above, in particular embodiments, the binder is crosslinkable. It is also understood that crosslinkable binders are also known as permanent wet strength binders. A permanent wet-strength binder includes, but is not limited to, Kymene® (Hercules Inc., Wilmington, Del.), Parez® (American Cyanamid Company, Wayne, N.J.), Wacker Vinnapas or AF192 (Wacker Chemie AG, Munich, Germany), or the like. Various permanent wet-strength agents are described in U.S. Pat. Nos. 2,345,543, 2,926,116, and 2,926,154, the disclosures of which are incorporated by reference in their entirety. Other permanent wet-strength binders include, but are not limited to, polyamine-epichlorohydrin, polyamide epichlorohydrin or polyamide-amine epichlorohydrin resins, which are collectively termed “PAE resins”. Non-limiting exemplary permanent wet-strength binders include Kymene 557H or Kymene 557LX (Hercules Inc., Wilmington, Del.) and have been described in U.S. Pat. Nos. 3,700,623 and 3,772,076, which are incorporated herein in their entirety by reference thereto.

Alternatively, in certain embodiments, the binder is a temporary wet-strength binder. The temporary wet-strength binders include, but are not limited to, Hercobond® (Hercules Inc., Wilmington, Del.), Parez® 750 (American Cyanamid Company, Wayne, N.J.), Parez® 745 (American Cyanamid Company, Wayne, N.J.), or the like. Other suitable temporary wet-strength binders include, but are not limited to, dialdehyde starch, polyethylene imine, mannogalactan gum, glyoxal, and dialdehyde mannogalactan. Other suitable temporary wet-strength agents are described in U.S. Pat. Nos. 3,556,932, 5,466,337, 3,556,933, 4,605,702, 4,603,176, 5,935,383, and 6,017,417, all of which are incorporated herein in their entirety by reference thereto.

In certain embodiments, the binder includes a plasticizer. Plasticizers include, but are not limited to, polyhydric alcohols such as glycerol; low molecular weight polyglycol such as polyethylene glycols and polyhydroxy compounds. These and other plasticizers are described and exemplified in U.S. Pat. Nos. 4,098,996, 5,547,541 and 4,731,269, all of which are hereby incorporated by reference in their entireties. For example, and not limitation, the plasticizer can be polyethylene glycol 100 (PEG 100, polyethylene glycol 200 (PEG 200), polyethylene glycol 300 (PEG 300), or polyethylene glycol 400 (PEG 400). Ammonia, urea, and alkylamines are also known to plasticize wood products, which mainly contain cellulose (A. J. Stamm, Forest Products Journal 5(6):413, 1955, hereby incorporated by reference in its entirety.

In particular embodiments of the disclosed subject matter, the following binder is used: Vinnapas 192, Wacker, 13.5% with 0.033 gsm of surfactant (Aerosol OT 75, Cytec Industries); (Vinnapas 192, Wacker, 25%) with 0.05 gsm of surfactant (Aerosol OT 75, Cytec Industries); Wacker Chemie AG VINNAPAS® 192 (13.5% or 15% solids); 1.6% Cytec Solvay Group AEROSOL® OT 75 (based upon binder solids); 0.8% Cytec Solvay Group AEROSOL® OT 75 (based upon binder solids); Celanese DUR-O-SET Elite 22 (13.5% solids).

In certain embodiments, binders can be applied as emulsions in amounts ranging from about from about 1 gsm to about 15 gsm, or from about 2 gsm to about 10 gsm, or from about 2 gsm to about 8 gsm, or from about 3 gsm to about 5 gsm. In particular embodiments, binders can be applied as emulsions in an amount of about 1 gsm, about 2 gsm, about 3 gsm, about 4 gsm, about 4.1 gsm, about 4.13 gsm, about 5 gsm, or about 6.5 gsm. In certain embodiments, binders can be applied as emulsions in an amount ranging from about 1% to about 30%, about 5% to about 25%, or about 10% to about 15%. In particular embodiments, binders can be applied as emulsions at about 11.8% or about 20% add-on. Binders can be applied to one side of a fibrous layer, preferably an externally facing layer. Alternatively, binder can be applied to both sides of a layer, in equal or disproportionate amounts. In certain embodiments, binders can be applied to at least one outer surface of a nonwoven material.

### Other Additives

The nonwoven materials of the presently disclosed subject matter can also include other additives. For example, the nonwoven materials can include superabsorbent polymer (SAP). The types of superabsorbent polymers which may be used in the disclosed subject matter include, but are not limited to, SAPs in their particulate form such as powder, irregular granules, spherical particles, staple fibers and other elongated particles. In certain embodiments, the materials can include superabsorbent fibers (SAF; manufactured by Technical Absorbents Limited, 9 dtex, 5.8 mm). U.S. Pat. Nos. 5,147,343, 5,378,528, 5,795,439, 5,807,916, 5,849,211, and 6,403,857, which are hereby incorporated by reference in their entireties, describe various superabsorbent polymers and methods of making superabsorbent polymers. One example of a superabsorbent polymer forming system is crosslinked acrylic copolymers of metal salts of acrylic acid and acrylamide or other monomers such as 2-acrylamido-2-methylpropanesulfonic acid. Many conventional granular superabsorbent polymers are based on poly(acrylic acid) which has been crosslinked during polymerization with any of a number of multi-functional co-monomer crosslinking agents well-known in the art. Examples of multi-functional crosslinking agents are set forth in U.S. Pat. Nos. 2,929,154, 3,224,986, 3,332,909, and 4,076,673, which are incorporated herein by reference in their entireties. For instance, crosslinked carboxylated polyelectrolytes can be used to form superabsorbent polymers. Other water-soluble polyelectrolyte polymers are known to be useful for the preparation of superabsorbents by crosslinking, these polymers include: carboxymethyl starch, carboxymethyl cellulose, chitosan salts, gelatine salts, etc. They are not, however, commonly used on a commercial scale to enhance absorbency of dispensable absorbent articles mainly due to their higher cost. Superabsorbent polymer granules useful in the practice of this subject matter are commercially available from a number of manufacturers, such as BASF, Dow Chemical (Midland, Mich.), Stockhausen (Greensboro, N.C.), Chemdal (Arlington Heights, Ill.), and Evonik (Essen, Germany). Non-limiting examples of SAP include a surface crosslinked acrylic acid based powder such as Stockhausen 9350 or SX70, BASF Hysorb Fem 33, BASF HySorb FEM 33N, or Evonik Favor SXM 7900.

In particular embodiments, the SAP can be starch-based. For example, the SAP can include K-Boost (XGF-450, manufactured by Corno Cascades LLC, Beavertown, Oreg.) or K-Boost (XGF 463, manufactured by Corno Cascades LLC, Beavertown, Oreg.). Such starched-based SAPs can be biodegradable. In certain embodiments, the SAP can include a high capacity SAP, a high-speed SAP, or combinations thereof. Particular examples of a high capacity SAP include K-Boost (XGF-450, manufactured by Corno Cascades LLC, Beavertown, Oreg.). Particular examples of a high-speed SAP include K-Boost (XGF 463, manufactured by Corno Cascades LLC, Beavertown, Oreg.).

In certain embodiments, SAP can be used in a layer in amounts ranging from about 5% to about 50% based on the total weight of the structure. In certain embodiments, the content of SAP is between about 0% and about 30%, about 0% and about 15%, about 5% and about 25%, about 5% and about 15%, or about 10% and about 20%, based on a total weight of the structure. In particular embodiments, the content of SAP is about 0%, about 2%, about 5%, about 8%, about 10%, about 15%, about 20%, about 25%, or about 30%, based on a total weight of the structure. In certain embodiments, the amount of SAP in a layer can range from about 5 gsm to about 50 gsm, about 5 gsm to about 25 gsm, about 10 gsm to about 50 gsm, or about 12 gsm to about 40 gsm, or about 15 gsm to about 25 gsm. In particular embodiments, SAP can be used in a layer in an amount of about 10 gsm or about 20 gsm.

### Nonwoven Materials

The presently disclosed subject matter provides for nonwoven materials having low dust or lint content. As embodied herein, the nonwoven material can include at least one layer, at least two layers, or at least three layers. In particular embodiments, the nonwoven material includes one layer.

As embodied herein, the nonwoven material can be an airlaid material. For example and not limitation, the material can be a thermally bonded airlaid (TBAL) material, a latex-bonded airlaid (LBAL) material or a multi-bonded airlaid (MBAL) material.

In certain embodiments, the nonwoven material can include a single layer comprising cellulose fibers. For example, any not by way of limitation, the layer can include cellulose fibers or cellulose fibers treated with a plasticizer (e.g., polyethylene glycol). The layer can further include a second type of cellulose fibers. For example and not limitation, the cellulose fibers can comprise modified cellulose fibers, cellulose fluff, and/or eucalyptus pulp. In particular embodiments, the cellulose fibers of a layer can comprise only cellulose fibers treated with plasticizer (e.g., polyethylene glycol).

For further example, in particular embodiments, the nonwoven material can include at least two layers, wherein at least one layer contains cellulose fibers. Thus, in certain embodiments, both layers of a two-layer structure can contain cellulose fibers. In alternate embodiments, one layer of the two-layer structure can contain cellulose fibers with the other layer containing bicomponent fibers.

Additionally, in certain embodiments, the nonwoven material can include a third layer, adjacent to the second layer. The third layer can optionally include cellulose fibers. Thus, in certain embodiments, all layers of a three-layer structure can contain cellulose fibers. The cellulose fibers on each layer can be the same type or difference types of cellulose fibers. In certain embodiments, the nonwoven material includes three or fewer layers.

Additionally or alternatively, the nonwoven material can be coated on at least of a portion of its outer surface with a binder. It is not necessary that the binder chemically bond with a portion of the layer, although it is preferred that the binder remain associated in close proximity with the layer, by coating, adhering, precipitation, or any other mechanism such that it is not dislodged from the layer during normal handling of the layer. For convenience, the association between the layer and the binder discussed above can be referred to as the bond, and the compound can be said to be bonded to the layer. If present, the binder can be applied in amounts ranging from about 1 gsm to about 15 gsm, or from about 2 gsm to about 10 gsm, or from about 2 gsm to about 8 gsm, or from about 3 gsm to about 5 gsm. Binders can be applied to one side of a fibrous layer, preferably an externally facing layer. Alternatively, binder can be applied to both sides of a layer, in equal or disproportionate amounts. In certain embodiments, binders can be applied to at least one outer surface of a nonwoven material.

Additionally or alternatively, the nonwoven material can include a layer of one or more plasticizers (e.g., polyethylene glycol). If present, the plasticizer can be applied in amounts ranging from about of about 0.1 gsm to about 10 gsm, about 0.5 gsm to about 5 gsm, or about 0.5 gsm to about 1.5 gsm. In particular embodiments, the nonwoven materials can include one or more plasticizers in an amount of about 0.7 gsm or about 1.4 gsm. Plasticizers can be included in nonwoven materials of the present disclosure in an amount of from about 1% to about 5% or from about 1% to about 2% of the total structure. In particular embodiments, the nonwoven material can include plasticizers in an amount of about 2% of the total structure. Plasticizers can be applied to one side of a fibrous layer, preferably an externally facing layer. Alternatively, plasticizer can be applied to both sides of a layer, in equal or disproportionate amounts. In certain embodiments, plasticizer can be applied to at least one outer surface of a nonwoven material.

In particular embodiments, the nonwoven material can include a first layer of cellulose fibers. The layer of cellulose fibers can include cellulose fibers treated with plasticizer (e.g., polyethylene glycol). In particular embodiments, the first layer can only include cellulose fibers treated with a plasticizer. In alternate embodiments, the first layer can only include non-treated cellulose fibers. The first layer can be coated with binder on at least one surface. In such embodiments, the first layer can further be coated with a plasticizer on at least one surface. Alternatively, the first layer can be coated with a plasticizer on at least one surface with the further addition of a binder on at least one surface of the first layer. Nonwoven materials of the present disclosure can further include a second layer of fibers. The second layer can include cellulose fibers, bicomponent fibers, and mixtures thereof. In particular embodiments, the second layer comprises only bicomponent fibers.

In certain embodiments, the nonwoven material can include at least three layers each comprising cellulose fibers. The first and third layer can include the same type of cellulose fibers. In particular embodiments, an intermediate layer can include fine cellulose fibers, such as eucalyptus pulp. The first layer and the third layer can be coated on an external surface with binder. In certain embodiments, a plasticizer can be further applied to at least one external surface of the nonwoven material.

Overall, the layers of the nonwoven material can have a basis weight of from about 5 gsm to about 100 gsm, or from about 30 gsm to about 80 gsm, or from about 50 gsm to about 75 gsm, or from about 50 gsm to about 65 gsm. In particular embodiments, the layers of the nonwoven material can have a basis weight of about 10 gsm, about 20 gsm, about 30 gm, about 40 gsm, or about 80 gsm.

The caliper of the nonwoven material, inclusive of all layers, can be from about 0.1 mm to about 1 mm, about 0.1 mm to about 0.8 mm, about 0.1 mm to about 8.0 mm, about 0.1 mm to about 7.5 mm, about 0.5 mm to about 6.0 mm, about 0.5 mm to about 4.0 mm, about 1.0 mm to about 4.0 mm, or from about 1.0 mm to about 3.5 mm. In particular embodiments, the caliper of the nonwoven material, inclusive of all layers, can be about 0.3 mm, about 0.4 mm, about 0.5 mm, about 0.6 mm, about 0.7 mm, about 0.8 mm, about 0.83 mm about 0.9 mm, or about 1 mm.

In certain embodiments, the nonwoven materials of the present disclosure can have a three dimensional surface topography. For example, and not by way of limitation, the nonwoven material can be patterned on at least one surface. The patterning can include “ridges” and “valleys”. The ridges ran in the cross-machine-direction (CD), and thus the nonwoven material can have areas of alternating high and low basis weight (“ridges” and “valleys”) in the machine direction (MD). The pattern of differential basis weight can impart unique properties to the sample absent from nonwoven materials having uniform basis weight throughout.

### Features of the Nonwoven Materials

Nonwoven materials of the present disclosure advantageously have low dust or lint content. Such nonwoven materials can also have adequate absorbency rate and capacity properties. The nonwoven materials of the present disclosure can include cellulose fibers pre-treated with plasticizer. The treatment of airlaid materials, bonded with ethylene-vinyl acetate (EVA) binders, with certain silicone-based chemicals can reduce the amount of lint. Further, treatment of such airlaid nonwoven materials with aqueous solution of polyethylene glycol (PEG) can also be used to reduce the dust or lint content. Additionally or alternatively, plasticizers can be added to the nonwoven material during the forming process.

The presently disclosed nonwoven materials can have a low dust content. In certain embodiments, nonwoven materials of the present disclosure can have a percent dust content of from about 0.1% to about 10%, about 1% to about 6%, or about 2% to about 5%. In particular embodiments, the nonwoven materials can have a percent dust content of about 5.5%, about 3.3.%, about 7.6%, or about 9.2%. In certain embodiments, nonwoven materials of the present disclosure can have a percent dust content of less than about 10%, less than about 8%, less than about 5%, or less than about 3%.

Nonwoven materials of the present disclosure can have an absorptive capacity of from about 5 g/g to about 15 g/g, about 5 g/g to about 10 g/g, or about 8 g/g to about 12 g/g. In particular embodiments, the nonwoven materials can have an absorptive capacity of about 8 g/g, about 9 g/g, about 10 g/g, about 11 g/g, about 12 g/g, about 13 g/g, or about 14 g/g. In certain embodiments, the nonwoven materials can have an absorptive capacity of at least about 6 g/g, at least about 8 g/g, at least about 10 g/g, at least about 11 g/g, or at least about 12 g/g.

Nonwoven materials of the present disclosure can have an absorbency rate of from about 1 second to about 15 seconds, about 3 seconds to about 10 seconds, from about 5 seconds to about 8 seconds, or from about 2 to about 2.5 seconds. In particular embodiments, the nonwoven materials can have an absorbency rate of about 1 second, about 1.5 seconds, about 2.0 seconds, about 2.5 seconds, about 3 seconds, about 6 seconds, about 7 seconds, about 10 seconds, about 11 seconds, or about 14 seconds. In certain embodiments, nonwoven materials can have an absorbency rate of about 2 seconds, about 4 seconds, about 5 seconds, or less than about 10 seconds, less than about 5 seconds, or less than about 2.5 seconds.

The presently disclosed nonwoven materials can have decreased percent fiber loss. In certain embodiments, the nonwoven materials can have a fiber loss of between about 5% and about 30%, about 5% and about 20%, or between about 10% and about 20%. In particular embodiments, the nonwoven materials can have a fiber loss of about 12%, about 13%, about 14%, about 15%, about 15.5%, about 16%, or about 17%. The presently disclosed nonwoven materials can have a low lint content.

In certain embodiments, the nonwoven materials can have a Gelbo sum value of from about 100 to about 500000, about 1000 to about 50000, or about 1000 to about 10000. In particular embodiments, the nonwoven materials can have a Gelbo sum value of about 1000, about 30000, about 40000, about 5000, about 8000, or about 10000. In particular embodiments, the nonwoven materials can have a Gelbo sum value of less than about 50000 or about 48697.

### Methods of Making the Nonwoven Materials

A variety of processes can be used to assemble the materials used in the practice of this disclosed subject matter to produce the materials, including but not limited to, traditional dry forming processes such as airlaying and carding or other forming technologies such as spunlace or airlace. Preferably, the materials can be prepared by airlaid processes. Airlaid processes include, but are not limited to, the use of one or more forming heads to deposit raw materials of differing compositions in selected order in the manufacturing process to produce a product with distinct strata. This allows great versatility in the variety of products which can be produced.

In one embodiment, the material is prepared as a continuous airlaid web. The airlaid web is typically prepared by disintegrating or defiberizing a cellulose pulp sheet or sheets, typically by hammermill, to provide individualized fibers. Rather than a pulp sheet of virgin fiber, the hammermills or other disintegrators can be fed with recycled airlaid edge trimmings and off-specification transitional material produced during grade changes and other airlaid production waste. Being able to thereby recycle production waste would contribute to improved economics for the overall process. The individualized fibers from whichever source, virgin or recycled, are then air conveyed to forming heads on the airlaid web-forming machine. A number of manufacturers make airlaid web forming machines suitable for use in the disclosed subject matter, including Dan-Web Forming of Aarhus, Denmark, M&J Fibretech A/S of Horsens, Denmark, Rando Machine Corporation, Macedon, N.Y. which is described in U.S. Pat. No. 3,972,092, Margasa Textile Machinery of Cerdanyola del Valles, Spain, and DOA International of Wels, Austria. While these many forming machines differ in how the fiber is opened and air-conveyed to the forming wire, they all are capable of producing the webs of the presently disclosed subject matter. The Dan-Web forming heads include rotating or agitated perforated drums, which serve to maintain fiber separation until the fibers are pulled by vacuum onto a foraminous forming conveyor or forming wire. In the M&J machine, the forming head is basically a rotary agitator above a screen. The rotary agitator may comprise a series or cluster of rotating propellers or fan blades. Other fibers, such as a synthetic thermoplastic fiber, are opened, weighed, and mixed in a fiber dosing system such as a textile feeder supplied by Laroche S. A. of Cours-La Ville, France. In particular embodiments, such airlaid machines can be equipped with customized forming heads or heads capable of layer individualized longer fibers. From the textile feeder, the fibers are air conveyed to the forming heads of the airlaid machine where they are further mixed with the comminuted cellulose pulp fibers from the hammer mills and deposited on the continuously moving forming wire. Where defined layers are desired, separate forming heads may be used for each type of fiber. Alternatively or additionally, one or more layers can be prefabricated prior to being combined with additional layers, if any.

The airlaid web is transferred from the forming wire to a calendar or other densification stage to densify the web, if necessary, to increase its strength and control web thickness. In one embodiment, the fibers of the web are then bonded by passage through an oven set to a temperature high enough to fuse the included thermoplastic or other binder materials. In a further embodiment, secondary binding from the drying or curing of a latex spray or foam application occurs in the same oven. The oven can be a conventional through-air oven, be operated as a convection oven, or may achieve the necessary heating by infrared or even microwave irradiation. In particular embodiments, the airlaid web can be treated with additional additives before or after heat curing.

The airlaid web can be cured one or more times during the forming process. In certain embodiments, the airlaid web can be cured at a temperature of between about 100° C. to about 200° C., about 125° C. to about 175° C. or between about 150° C. to about 170° C. In particular embodiments, the airlaid web can be cured at a temperature of about 150° C., about 160° C., or about 170° C. The airlaid web can be cured for a period of time of from about 1 minute to about 10 minutes, about 2 minutes to about 8 minutes, or about 1 minute to about 5 minutes. In particular embodiments, the airlaid web can be cured for about 4 minutes or about 5 minutes. In certain embodiments, the airlaid web can be cured on moving lines. In certain embodiments, the airlaid web can be cured for from about 3 seconds to about 5 seconds on moving lines.

In certain embodiments, one or more plasticizers such as polyethylene glycol can be applied on a cellulose sheet before being disintegrated in hammermills or it can be applied by spraying on the airlaid web either during the forming process or at the end of the airlaid line after the curing of the binders has been completed. The use silicone-based chemicals can be sprayed onto the web either after being formed and before being cured, or at the end of the Airlaid line. Polyethylene glycol polymers are hydrophilic unlike silicone-based chemicals and can also be more economical than silicones. In particular embodiments, polyethylene glycol can be added to the pulp pre-hammermill. In further particular embodiments, polyethylene glycol can be added to an airlaid embodiment by first spraying airlaid web with a binder and followed immediately by spraying the wet sheet with polyethylene glycol. The airlaid web can then be dried in the oven.

### Applications and End Uses

The nonwoven materials of the disclosed subject matter can be used for any application known in the art. For example, the nonwoven materials can be used alone or as a component in consumer products. For example, the nonwoven materials can be used in cleaning products, such wipes, sheets, towels and the like. By way of example, the nonwoven materials can be used as a disposable wipe for cleaning applications, including household, personal, and industrial cleaning applications, or as tray liners, or medical drapes.

### 6. EXAMPLES

The following examples are merely illustrative of the presently disclosed subject matter and they should not be considered as limiting the scope of the subject matter in any way.

### Example 1: Low-Dust Latex-Bonded Airlaid (LBAL) Nonwovens—Dust Testing

The present Example provides for latex-bonded airlaid (LBAL) nonwovens of the present disclosure and methods of making the same. Such nonwovens advantageously had a reduced dust content.

Structure 1A was an airlaid LBAL structure made using cellulose fibers and a lab padformer. Structure 1A was formed by laying 52 gsm of cellulose fiber (Golden Isle 4725, semi-treated pulp from Georgia Pacific, Leaf River) on the padformer. The structure was sprayed with 6.5 gsm of polymeric binder (binder dry weight) in the form of an emulsion (Vinnapas 192, Wacker, 25%) with 0.05 gsm of surfactant (Aerosol OT 75, Cytec Industries). Structure 1A was cured in a 150° C. oven for 5 minutes. The other side of the structure was sprayed with 6.5 gsm of polymeric binder (binder dry weight) in the form of an emulsion (Vinnapas 192, Wacker, 25%) with 0.05 gsm of surfactant (Aerosol OT 75, Cytec Industries). The total binder add-on for the LBAL structure was 20%. Structure 1A was then cured a second time in the 150° C. oven for 5 minutes.

The composition of Structure 1A is shown in Table 1.

TABLE 1
Structure 1A Composition

| | | | Basis |
|---|---|---|---|
| | Type of | | Weight |
| Layer | Material | Raw Materials | (gsm) |
| | Binder | Vinnapas 192, Wacker, 25% with | 6.5 |
| | | 0.05 gsm of surfactant Aerosol OT | |
| | | 75, Cytec Industries | |
| 1 | Pulp | Golden Isle 4725, semi-treated | 52.0 |
| | | pulp from Georgia Pacific, | |
| | | Leaf River | |
| | Binder | Vinnapas 192, Wacker, 25% with | 6.5 |
| | | 0.05 gsm of surfactant Aerosol OT | |
| | | 75, Cytec Industries | |
| | | Total | 65.00 |

Structure 1B was an airlaid LBAL structure made using cellulose fibers pre-treated with Carbowax Sentry Polyethylene Glycol 400 NF (from The Dow Chemical Company) and a lab padformer. Carbowax Sentry Polyethylene Glycol 400 NF (from The Dow Chemical Company) was diluted to a 2% solution and then sprayed onto pulp sheets of cellulose fibers (Golden Isle 4725, semi-treated pulp from Georgia Pacific, Leaf River). The total polyethylene glycol (PEG) add-on was 1% (based on the ambient pulp sheet weight). The pulp sheets were air-dried for approximately 2 days. The sheets were then disintegrated by a hammermill and collected at the forming head. The PEG-treated cellulose pulp was then used to form Structure 1B. Structure 1B was formed by laying 52 gsm of PEG-treated cellulose fiber (Golden Isle 4725, semi-treated pulp from Georgia Pacific, Leaf River) on the padformer. The structure was sprayed with 6.5 gsm of polymeric binder (binder dry weight) in the form of an emulsion (Vinnapas 192, Wacker, 25%) with 0.05 gsm of surfactant (Aerosol OT 75, Cytec Industries). Structure 1B was cured in a 150° C. oven for 5 minutes. The other side of the structure was sprayed with 6.5 gsm of polymeric binder (binder dry weight) in the form of an emulsion (Vinnapas 192, Wacker, 25%) with 0.05 gsm of surfactant (Aerosol OT 75, Cytec Industries). The total binder add-on for the LBAL structure was 20%. Structure 1B was then cured a second time in the 150° C. oven for 5 minutes.

The composition of Structure 1B is shown in Table 2.

TABLE 2
Structure 1B Composition

| | | | Basis |
|---|---|---|---|
| | Type of | | Weight |
| Layer | Material | Raw Materials | (gsm) |
| | Binder | Vinnapas 192, Wacker, 25% with | 6.5 |
| | | 0.05 gsm of surfactant Aerosol OT | |
| | | 75, Cytec Industries | |
| 1 | Pulp | Golden Isle 4725, semi-treated | 52.0 |
| | | pulp from Georgia Pacific, Leaf | |
| | | River (1% Carbowax Sentry | |
| | | Polyethylene Glycol 400 NF) | |
| | Binder | Vinnapas 192, Wacker, 25% with | 6.5 |
| | | 0.05 gsm of surfactant Aerosol OT | |
| | | 75, Cytec Industries | |
| | | Total | 65.00 |

Dust Testing

A sample of each structure was cut to ½ in.×½ in. squares and weighed. The cut pieces of material were then placed into a No. 14 sieve (12 mesh; 1.40 mm opening). A lid was placed on top of the sieve. The cut samples were agitated with a moving air stream (30 psi). A vacuum was simultaneously applied to remove the loose lint and fibers. The total vacuum applied to the cut samples was 3 cm Hg. The experiment was continuously run for 7 minutes. Afterward, the cut samples of material were weighed. The percent dust was then calculated by using the following formula:

$$dust \% = \frac{Initial sample wt - sample wt after air agitation}{Initial sample weight} \times 100$$

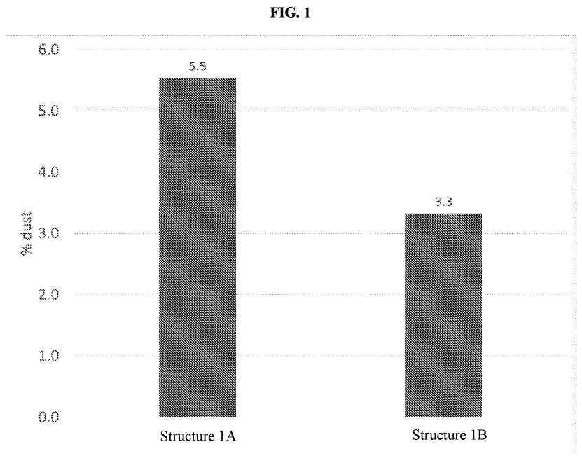

The test results are provided in FIG. 1.

As shown in FIG. 1, Sample 1A had a dust value of 5.5%, whereas Sample 1B which included cellulose fibers pre-treated with polyethylene glycol (PEG) exhibit a lower dust content at 3.3%.

### Example 2: Low-Dust Thermally-Bonded Airlaid (TBAL) Nonwovens—Dust Testing

The present Example provides for thermally-bonded airlaid (TBAL) nonwovens of the present disclosure and methods of making the same. Such nonwovens advantageously had a reduced dust content.

Structure 2A was an airlaid TBAL structure made by homogeneously mixing cellulose fibers and bicomponent fibers on a lab padformer. Structure 2A was formed by mixing 40 gsm of cellulose fiber (Golden Isle 4725, semi-treated pulp from Georgia Pacific, Leaf River) with 10 gsm of bicomponent fiber (Trevira 1661, 2.2 dtex, 6 mm, Type 255) and laying the mixture down on a padformer. The structure was cured in a 150° C. oven for 4 minutes.

The composition of Structure 2A is shown in Table 3.

TABLE 3
Structure 2A Composition

| | | | Basis |
|---|---|---|---|
| | Type of | | Weight |
| Layer | Material | Raw Materials | (gsm) |
| 1 | Pulp | Golden Isle 4725, semi-treated | 40.0 |
| | | pulp from Georgia Pacific, | |
| | | Leaf River | |
| | Synthetic | Trevira 1661, 2.2 dtex, | 10.0 |
| | | 6 mm, Type 255 | |
| | | Total | 50.0 |

Structure 2B was an airlaid TBAL structure made by homogeneously mixing bicomponent fibers and cellulose fibers pre-treated with Carbowax Sentry Polyethylene Glycol 400 NF (from The Dow Chemical Company) using a lab padformer. Carbowax Sentry Polyethylene Glycol 400 NF (from The Dow Chemical Company) was diluted to a 2% solution and then sprayed onto pulp sheets of cellulose fibers (Golden Isle 4725, semi-treated pulp from Georgia Pacific, Leaf River). The total polyethylene glycol (PEG) add-on was 1% (based on the ambient pulp sheet weight). The pulp sheets were air-dried for approximately 2 days. The sheets were then disintegrated by a hammermill and collected at the forming head. The PEG-treated pulp was then used to form Structure 2B. Structure 2B was formed by laying a homogeneous mixture of 40 gsm of PEG-treated cellulose fiber (Golden Isle 4725, semi-treated pulp from Georgia Pacific, Leaf River) and 10 gsm of bicomponent fiber (Trevira 1661, 2.2 dtex, 6 mm, Type 255) on the padformer. The structure was cured in a 150° C. oven for 4 minutes.

The composition of Structure 2B is shown in Table 4.

TABLE 4
Structure 2B Composition

| | | | Basis |
|---|---|---|---|
| | Type of | | Weight |
| Layer | Material | Raw Materials | (gsm) |
| 1 | Pulp | Golden Isle 4725, semi-treated | 40.0 |
| | | pulp from Georgia Pacific, Leaf | |
| | | River (1% Carbowax Sentry | |
| | | Polyethylene Glycol 400 NF) | |
| | Synthetic | Trevira 1661, 2.2 dtex, | 10.0 |
| | | 6 mm, Type 255 | |
| | | Total | 50.0 |

Dust Testing

A sample of each structure was cut to ½ in.×½ in. squares and weighed. The cut pieces of material were then placed into a No. 14 sieve (12 mesh; 1.40 mm opening). A lid was placed on top of the sieve. The cut samples were agitated with a moving air stream (30 psi). A vacuum was simultaneously applied to remove the loose lint and fibers. The total vacuum applied to the cut samples was 3 cm Hg. The experiment was continuously run for 7 minutes. Afterward, the cut samples of material were weighed. The percent dust was then calculated following the same formula as in Example 1.

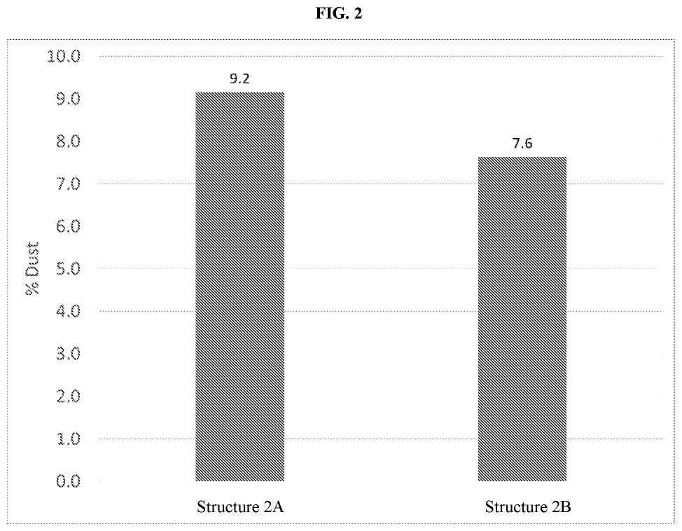

The test results are provided in FIG. 2.

As shown in FIG. 2, Sample 2A had a dust value of 9.2%, whereas Sample 2B which included cellulose fibers pre-treated with polyethylene glycol (PEG) exhibit a lower dust content at 7.6%.

### Example 3: Low-Dust Latex-Bonded Airlaid (LBAL) Nonwovens (Pilot Line)

The present Example provides for latex-bonded airlaid (LBAL) nonwovens of the present disclosure and methods of making the same.

Structure 3A was an airlaid LBAL made on pilot line. Structure 3A was formed by laying 60.3 gsm of cellulose fiber (Golden Isle 4725, semi-treated pulp from Georgia Pacific, Leaf River). The structure was sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) on the topside and cured in the oven for 7 seconds at 170° C. The bottom side was also sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) before curing in the oven for 20 seconds at 170° C. The total binder add-on for the LBAL structure was 11.8%.

The composition of Structure 3A is shown in Table 5.

TABLE 5
Structure 3A Composition

| | | | Basis |
|---|---|---|---|
| | Type of | | Weight |
| Layer | Material | Raw Materials | (gsm) |
| | Binder | Vinnapas 192, Wacker, 13.5% | 4.13 |
| | | with 0.033 gsm of surfactant | |
| | | (Aerosol OT 75, Cytec Industries) | |
| 1 | Pulp | Golden Isle 4725, semi-treated | 60.3 |
| | | pulp from Georgia Pacific, | |
| | | Leaf River | |
| | Binder | Vinnapas 192, Wacker, 13.5% | 4.13 |
| | | with 0.033 gsm of surfactant | |
| | | (Aerosol OT 75, Cytec Industries) | |
| | | Total | 68.56 |

Structure 3B was an airlaid LBAL made on the pilot line. Structure 3B was formed by laying 60.3 gsm of cellulose fiber (Golden Isle 4725, semi-treated pulp from Georgia Pacific, Leaf River). The structure was sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) on the topside and cured in the oven for 7 seconds at 170° C. The bottom side was also sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) before curing in the oven for 20 seconds at 170° C. The total binder add-on for the LBAL structure was 11.8%. Upon exiting the last oven, the airlaid sheet was sprayed with a 10% solution of polyethylene glycol 400 solution on the topside. The total polyethylene glycol 400 applied was 1.4 gsm or 2% of the total structure.

The composition of Structure 3B is shown in Table 6.

TABLE 6
Structure 3B Composition

| | | | Basis |
|---|---|---|---|
| | Type of | | Weight |
| Layer | Material | Raw Materials | (gsm) |
| | PEG | 10% solution of polyethylene | 1.4 |
| | | glycol (PEG) 400 solution | |
| | Binder | Vinnapas 192, Wacker, 13.5% | 4.13 |
| | | with 0.033 gsm of surfactant | |
| | | (Aerosol OT 75, Cytec Industries) | |
| 1 | Pulp | Golden Isle 4725, semi-treated | 60.3 |
| | | pulp from Georgia Pacific, | |
| | | Leaf River | |
| | Binder | Vinnapas 192, Wacker, 13.5% | 4.13 |
| | | with 0.033 gsm of surfactant | |
| | | (Aerosol OT 75, Cytec Industries) | |
| | | Total | 69.96 |

Structure 3C was an airlaid LBAL made on the pilot line. Structure 3C was formed by laying 60.3 gsm of cellulose fiber (Golden Isle 4725, semi-treated pulp from Georgia Pacific, Leaf River). The structure was sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) on the topside. While the airlaid sheet was still wet, it was sprayed with 0.7 gsm of polyethylene glycol 400 and then cured in the oven for 7 seconds at 170° C. The bottom side was also sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries). With no drying or curing, the wet airlaid sheet was sprayed with 0.7 gsm of polyethylene glycol 400 and then cured in the oven for 20 seconds at 170° C. The total binder add-on for the LBAL structure was 11.8%. The total polyethylene glycol 400 add-on was 1.4 gsm or 2% of the total structure.

The composition of Structure 3C is shown in Table 7.

TABLE 7
Structure 3C Composition

| | | | Basis |
|---|---|---|---|
| | Type of | | Weight |
| Layer | Material | Raw Materials | (gsm) |
| | PEG | Polyethylene glycol 400 | 0.70 |
| | Binder | Vinnapas 192, Wacker, 13.5% | 4.13 |
| | | with 0.033 gsm of surfactant | |
| | | (Aerosol OT 75, Cytec Industries) | |
| 1 | Pulp | Golden Isle 4725, semi-treated | 60.3 |
| | | pulp from Georgia Pacific, | |
| | | Leaf River | |
| | Binder | Vinnapas 192, Wacker, 13.5% | 4.13 |
| | | with 0.033 gsm of surfactant | |
| | | (Aerosol OT 75, Cytec Industries) | |
| | PEG | Polyethylene glycol 400 | 0.70 |
| | | Total | 69.96 |

Structure 3D was an airlaid LBAL made on the pilot line. Structure 3D was formed by laying 60.3 gsm of cellulose fiber (Golden Isle 4725, semi-treated pulp from Georgia Pacific, Leaf River). The structure was sprayed with 0.7 gsm of polyethylene glycol 400 on the topside. While the airlaid sheet was still wet, it was further sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) on the topside and then cured in the oven for 7 seconds at 170° C. The bottom side was also sprayed with 0.7 gsm of polyethylene glycol 400. With no drying or curing, the wet airlaid sheet was sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries). The wet sheet was then cured in the oven for 20 seconds at 170° C. The total binder add-on for the LBAL structure was 11.8%. The total polyethylene glycol 400 add-on was 1.4 gsm or 2% of the total structure.

The composition of Structure 3D is shown in Table 8.

TABLE 8
Structure 3D Composition

| | | | Basis |
|---|---|---|---|
| | Type of | | Weight |
| Layer | Material | Raw Materials | (gsm) |
| | Binder | Vinnapas 192, Wacker, 13.5% | 4.13 |
| | | with 0.033 gsm of surfactant | |
| | | (Aerosol OT 75, Cytec Industries) | |
| | PEG | Polyethylene glycol 400 | 0.70 |
| 1 | Pulp | Golden Isle 4725, semi-treated | 60.3 |
| | | pulp from Georgia Pacific, | |
| | | Leaf River | |
| | PEG | Polyethylene glycol 400 | 0.70 |
| | Binder | Vinnapas 192, Wacker, 13.5% | 4.13 |
| | | with 0.033 gsm of surfactant | |
| | | (Aerosol OT 75, Cytec Industries) | |
| | | Total | 69.96 |

Structure 3E was an airlaid LBAL made on the pilot line. Structure 3E was formed by laying 61.7 gsm of PEG 400-treated cellulose fiber (Golden Isle 4725, semi-treated pulp from Georgia Pacific, Leaf River). Polyethylene glycol 400 was added to the pulp sheet in the amount of 2.267% polyethylene glycol 400 (based on pulp weight) prior to disintegration in a hammermill. Thus, a 70 gsm structure would have 1.4 gsm of polyethylene glycol 400. The airlaid structure was sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) on the topside and cured in the oven for 7 seconds at 170° C. The bottom side was also sprayed with 4.13 gsm of polymeric binder (binder dry weight) in the form of an emulsion (Vinnapas 192, Wacker, 13.5%) with 0.033 gsm of surfactant (Aerosol OT 75, Cytec Industries) before curing in the oven for 20 seconds at 170° C. The total binder add-on for the LBAL structure was 11.8%.

The composition of Structure 3E is shown in Table 9.

TABLE 9
Structure 3E Composition

| | | | Basis |
|---|---|---|---|
| | Type of | | Weight |
| Layer | Material | Raw Materials | (gsm) |
| | Binder | (Vinnapas 192, Wacker, 13.5%) | 4.13 |
| | | with 0.033 gsm of surfactant | |
| | | (Aerosol OT 75, Cytec Industries) | |
| 1 | Pulp | PEG 400-treated cellulose fiber | 61.7 |
| | | (Golden Isle 4725, semi-treated | |
| | | pulp from Georgia Pacific, | |
| | | Leaf River | |
| | Binder | (Vinnapas 192, Wacker, 13.5%) | 4.13 |
| | | with 0.033 gsm of surfactant | |
| | | (Aerosol OT 75, Cytec Industries) | |
| | | Total | 69.96 |

Gelbo Sum Value All Lint Classes

The measure used to report fiber linting is the Gelbo Lint analysis according to NWSP 160.1.R0 (15) Resistance to Linting of Nonwoven Fabrics (Dry) as performed by SGS-IPS Testing, which is incorporated by reference herein in its entirety. This test measured particles shed from the surface of a material during a twisting and flexing motion and collected by a particle counter. Data from lint testing is returned as numbers of particles in a variety of different lint classes (>0.5 μm, >1.0 μm, >2.0 μm, >3.0 μm, >5.0 μm, >7.0 μm, >10.0 μm, and >25.0 μm). The average value for each of those classes was added together to result in a sum value for all lint classes measured.

The samples and test results are provided in Table 10.

TABLE 10
Fiber Linting Test Results (Samples 3A to 3E)

| | | Gelbo Sum Value |
|---|---|---|
| Sample | Comments | All Lint Classes |
| 3A | N/A | 177688 |
| 3B | PEG 400 was only | 96442 |
| | sprayed on the Airlaid’s | |
| | topside and the tested | |
| | side was the topside | |
| 3B | PEG 400 was only | 72887 |
| | sprayed on the Airlaid’s | |
| | topside but the tested | |
| | side was the bottomside | |
| 3C | N/A | 65672 |
| 3D | N/A | 72845 |
| 3E | N/A | 59457 |

### Example 4: Commercial Samples—Lint and Dust Testing

The present Example provides lint and dust testing of commercially available nonwoven products. Various commercial samples of nonwoven products were tested for fiber loss and Gelbo Sum Value All Lint Classes. Commercial Samples A-O are provided in Table 11.

Dust Testing

0.2032-meter by 0.254-meter sheets were cut into 1.27-centimeter square pieces and agitated in a U.S.A. Standard Testing Sieve No. 14 with rotating air nozzles (30 psi, 400-410 rpm) for 7 minutes. A vacuum was simultaneously applied to remove the loose lint and fibers. The total vacuum applied to the cut samples was 3 cm Hg.

Samples were measured in triplicate. The percent difference in the initial weight and the final weight after agitation is the % fiber loss. Larger % fiber loss numbers indicate that the samples will create more dust in use and during converting operations.

### Gelbo Sum Value All Lint Classes

The measure used to report fiber linting is the Gelbo Lint analysis according to NWSP 160.1.R0 (15) Resistance to Linting of Nonwoven Fabrics (Dry) as performed by SGS-IPS Testing. This test measured particles shed from the surface of a material during a twisting and flexing motion and collected by a particle counter. Data from lint testing is returned as numbers of particles in a variety of different lint classes (>0.5 μm, >1.0 μm, >2.0 μm, >3.0 μm, >5.0 μm, >7.0 μm, >10.0 μm, and >25.0 μm). The average value for each of those classes was added together to result in a sum value for all lint classes measured.

The samples and test results are provided in Table 11.

TABLE 11
Commercial Samples-Lint and Dust Testing

| | | | | | | | Gelbo | |
|---|---|---|---|---|---|---|---|---|
| | | | | | | | Sum | |
| | | Basis | | % | | % | Value | |
| | | Weight | Emboss | Binder | Binder | Fiber | All Lint | Caliper |
| Sample | Grade | (gsm) | Pattern | Content | Type | Loss | Classes | (mm) |
| A | 6043 | 49 | None | 13% | Celanese | 5.40% | N/A | 0.44 |
| | LBAL | | | | DUR-O- | | | |
| | | | | | SET | | | |
| | | | | | Elite 22 | | | |
| B | 6807 | 52 | Spot | 14% | Celanese | 5.90% | N/A | 0.61 |
| | LBAL | | | | DUR-O- | | | |
| | | | | | SET | | | |
| | | | | | Elite 22 | | | |
| C | Halyard | 64 | N/A | N/A | N/A | 5.60% | N/A | N/A |
| | Sample | | | | | | | |
| | hydro knit | | | | | | | |
| D | FX0439 | 60 | Spot | 13% | Celanese | 2.60% | 70936 | 0.67 |
| | LBAL | | | | DUR-O- | | | |
| | | | | | SET | | | |
| | | | | | Elite 22 | | | |
| E | 350 | 57.5 | Smooth | 23% | Wacker | 2.80% | 223821 | N/A |
| | LBAL | | | | Vinnapas | | | |
| | | | | | 192 | | | |
| F | FX0439 | 60 | Spot | 13% | Celanese | 2.00% | N/A | 0.67 |
| | LBAL | | | | DUR-O- | | | |
| | | | | | SET | | | |
| | | | | | Elite 22 | | | |
| G | WypAll | 80 | N/A | N/A | N/A | 1.30% | N/A | N/A |
| | hydro knit | | | | | | | |
| H | 85902 | 50 | TAM | 13% | Celanese | 3.50% | 1149305 | 0.52 |
| | LBAL | | | | DUR-O- | | | |
| | | | | | SET | | | |
| | | | | | Elite 22 | | | |
| I | FX0574 | 55 | TAM | 15% | Celanese | 3.20% | N/A | N/A |
| | LBAL | | | | DUR-O- | | | |
| | | | | | SET | | | |
| | | | | | Elite 22 | | | |
| J | FX0527 | 50 | Double-S | 26% | Wacker | 5.50% | N/A | N/A |
| | LBAL | | | | Vinnapas | | | |
| | | | | | 192 | | | |
| K | 6042 | 55 | Unembossed | 13% | Wacker | 3.50% | N/A | 0.76 |
| | LBAL | | | | Vinnapas | | | |
| | | | | | 192 | | | |
| L | 215156 | 70 | Spot | 19% | Wacker | 7.20% | 245156 | 0.82 |
| | LBAL | | | | Vinnapas | | | |
| | | | | | 192 | | | |
| M | 6802 | 75 | Spot | 11% | Celanese | N/A | 138331 | 0.85 |
| | LBAL | | | | DUR-O- | | | |
| | | | | | SET | | | |
| | | | | | Elite 22 | | | |
| N | 6219 | 55 | Linen | 10% | Wacker | N/A | 75094 | 0.54 |
| | LBAL | | | | Vinnapas | | | |
| | | | | | 192 | | | |
| O | Halyard | N/A | N/A | N/A | N/A | N/A | 48697 | N/A |
| | Sample | | | | | | | |
| | Tray liner | | | | | | | |
| | HK63 | | | | | | | |
| | (Target Lint | | | | | | | |
| | Value) | | | | | | | |

As provided in Tale 10, there was no correlation between % fiber loss and Gelbo lint values. It is important to designate for the product under evaluation if a reduction in fiber loss (often called dust) or linting is being measured. For these evaluations, a reduction in linting was preferred. A sample with 2.6% fiber loss had a Gelbo lint value of 70936 (Sample D) and a different sample with a % fiber loss value of 2.8% had a Gelbo lint value of 223821 (Sample E). It is preferable to have a lower value than the Halyard Sample Tray liner HK63 (48697 Gelbo) (Sample 0). The closest untreated commercial airlaid sample that was evaluated for Gelbo lint was a spot embossed 60 gsm LBAL containing 13% of a soft (low TG) binder Celanese DUR-O-SET Elite 22 (70936 Gelbo) (Sample D).

### Example 5: Low-Dust Airlaid Nonwovens—Silicone-Based Emulsion Testing (Post-Treatment) (Pilot Plant)

The present Example provides for testing of the application of silicone-based fluid emulsions as plasticizers to provide low-dust nonwoven materials. Such materials were tested after treatment with the plasticizer.

Sample Roll Preparation

A 65 gsm sample was formed in three layers on a Dan-Web airlaid machine at 30 meters/minute, utilizing an Albany RibTech 84 forming wire. The bottom layer contained 18 gsm of cellulose fiber (Georgia Pacific Golden Isles® Semi-Treated Pulp Grade 4725), the middle layer contained 21 gsm of cellulose fiber (Stora Enso Semi-Treated EF Pulp), and the top layer contained 18 gsm of cellulose fiber (Georgia Pacific Golden Isles® Semi-Treated Pulp Grade 4725). After forming, the sample was densified with 3.5 bar of compaction. The sample was bonded by spraying 4 gsm binder application of Wacker Chemie AG VINNAPAS® 192 at 18% solids on each side and then dried in a through-air dryer at 170° C. Due to the surface topography of the forming wire, the side of the sample formed nearest the wire has a ridged surface. The ridges ran in the cross-machine-direction (CD), thus the sample had areas of alternating high and low basis weight (“ridges” and “valleys”) in the machine direction (MD). The pattern of differential basis weight imparted unique properties to the sample, which were not present in samples having uniform basis weight throughout. Particularly, the patterned forming wire used in preparation of this sample provided samples having higher dust levels. All samples 1.6% Cytec Solvay Group AEROSOL® OT 75 based upon binder solids.

Without being bound to particular theory, the formation topography differences provided by the RibTech 84 forming wire can provide significant increase in sample bulk as measured by caliper at 0.823 mm, which may be counter balanced by an increase in levels of fiber loss for latex bonded airlaid structures. For samples bonded with bicomponent fibers, the adhesive component is distributed throughout the structure.

The sample was absorbent with an average 2.24 second absorbency time in initial testing with water and had an absorptive capacity of 12.675 g/g in water. Initial testing also provided that the sample had a relatively high % fiber loss at 16.2%. Thus, any differences in linting or fiber loss could be readily measured.

Sample Preparation (Samples 5-1 to 5-11)

10-inch cross direction by 12-inch machine direction samples were cut from the center of the sample roll. Wacker E335 (35% actives) was diluted to 5% actives. 1% total of the Wacker E335 was sprayed on each sheet with one half applied to each side. Due to the anticipated hydrophobic tendencies of some silicones, for some samples, Wacker TS 533 was added at varying levels to the 5% actives Wacker E335 as provided in Table 12. For Sample 5-1, only Wacker TS 533 was added. For other samples, either water or no spray at all were added to serve as controls (i.e., Samples 5-9 and 5-11).

TABLE 12
Sample Preparation (Samples 5-1 to 5-11)

| | % Wacker | | | |
|---|---|---|---|---|
| | E335 | | | |
| | Actives | % Wacker | | |
| | addition to | TS 533 | | |
| | Sheet | Actives | % Water | |
| | (including | added to | addition | |
| | any Wacker | Wacker | to sheet | Drying |
| Sample | TS 533) | E335 | (for control) | Method |
| 5-1 | 0 | 1.0 | 0 | Air dried |
| 5-2 | 0 | 0.0025 | 0 | Air dried |
| 5-3 | 1 | 0.005 | 0 | Air dried |
| 5-4 | 1 | 0.0075 | 0 | Air dried |
| 5-5 | 1 | 0.01 | 0 | Air dried |
| 5-6 | 1 | 0.015 | 0 | Air dried |
| 5-7 | 1 | 0.02 | 0 | Air dried |
| 5-8 | 1 | 0 | 0 | Air dried |
| 5-9 | 0 | 0 | 1 | Air dried |
| 5-10 | 1 | 0 | 0 | Oven dried |
| | | | | 150° C. 3 min |
| 5-11 | 0 | 0 | 0 | Not applicable |

Sample Preparation (Samples 5-12 to 5-19)

Samples were also tested with higher Wacker E335 content. 10-inch cross direction by 12-inch machine direction samples were cut from the center of the same sample roll. Wacker E335 (35% actives) was diluted to 5% actives. 1 to 2% total of the Wacker E335 was sprayed on each sheet with one half applied to each side. Due to the anticipated hydrophobic tendencies of some silicones, for some samples, Wacker TS 533 was added at varying levels to the 5% actives Wacker E335 as provided in Table 13. For sample 5-1, only Wacker TS 533 was added. For other samples, either water or no spray at all were added to serve as controls (i.e., Samples 5-14 and 5-16).

TABLE 13
Sample Preparation (Samples 5-12 to 5-19)

| | % Wacker | | | |
|---|---|---|---|---|
| | E335 | | | |
| | Actives | % Wacker | | |
| | addition to | TS 533 | | |
| | Sheet | Actives | % Water | |
| | (including | added to | addition | |
| | any Wacker | Wacker | to sheet | Drying |
| Sample | TS 533) | E335 | (for control) | Method |
| 5-12 | 1 | 1 | 0 | Oven dried |
| | | | | 150° C. 3 min |
| 5-13 | 1 | 0 | 0 | Air dried |
| 5-14 | 0 | 0 | 1 | Air dried |
| 5-15 | 1 | 0 | 0 | Oven dried |
| | | | | 150° C. 3 min |
| 5-16 | 0 | 0 | 0 | Not applicable |
| 5-17 | 2 | 0 | 0 | Air dried |
| 5-18 | 2 | 0 | 0 | Oven dried |
| | | | | 150° C. 3 min |
| 5-19 | 1 | 0.5 | 0 | Oven dried |
| | | | | 150° C. 3 min |

Sample Testing

Samples 5-1 to 5-19 were tested for fiber loss, absorbency rate, and absorptive capacity. Samples 5-12 to 5-19 were additionally tested for Gelbo Sum Value All Lint Classes. Fiber loss testing and Gelbo Sum Value All Lint Classes testing were performed as provided in Example 4.

Absorbency Rate Testing

Samples were weighed to 5 g+/−0.1 g (dry weight). A wire basket (3.0 g+/−0.03 g) was placed on a balance and the balance was tared. The sample was folded and rolled loosely and placed in the basket. The sample dry weight was recorded if absorptive capacity was to be calculated. The basket was dropped from a height of 25 mm into a container of 750 mL tap water at room temperature and a timer was started. When the sample was fully submerged, the timer was stopped. The time recorded was the absorbency rate. The sample was then used to determine absorptive capacity.

Absorptive Capacity Testing

The absorbency rate sample was allowed to stay submerged for 60 seconds, and then the basket (with the sample) was removed from the water and hung. Water was allowed drain freely from the basket (with the sample) for 120 seconds. At the end of 120 seconds, the basket (with the sample) was placed on the tared balance. The sample wet weight was recorded. The water absorbed by the sample was calculated and reported as grams per gram.

The test results for Samples 5-1 to 5-11 are provided in Table 14.

TABLE 14
Test Results (Samples 5-1 to 5-11)

| | Absorbency | Absorptive | % Fiber |
|---|---|---|---|
| Sample | Rate(s) | Capacity (g/g) | Loss |
| 5-1 | 2.48 | 13.94 | 13.5 |
| 5-2 | 3.31 | 14.57 | 15.5 |
| 5-3 | 4.05 | 14.7 | 15.6 |
| 5-4 | 2.69 | 14.19 | 15.4 |
| 5-5 | 3.03 | 14.4 | 15.9 |
| 5-6 | 2.77 | 13.97 | 16.1 |
| 5-7 | 2.6 | 14.17 | 15.7 |
| 5-8 | 3.14 | 14.4 | 14.6 |
| 5-9 | 1.42 | 13.77 | 12.8 |
| 5-10 | 3.26 | 13.61 | 17.4 |
| 5-11 | 1.59 | 11.87 | 16.7 |

While some samples did appear marginally slower in water uptake, their capacities for water remained intact. Fiber loss did not seem to be significantly impacted by treatment with Wacker E335. The greatest reduction in fiber loss was achieved for the water control. Because these samples were observed to lint significantly less after treatment during preparation, it was further investigated whether fiber loss was a representative measure for linting as measured by Gelbo Lint analysis according to NWSP 160.1.R0 (15) Resistance to Linting of Nonwoven Fabrics (Dry) as performed by SGS Integrated Paper Services, Inc. (Appleton, Wis.). Because fiber loss involves increasing the number of cut edges and allowing whole fibers to escape in the turbulent testing atmosphere, and Gelbo lint testing is a gentler flexing in a controlled environment that allows particles or fibers to escape from a testing surface, additional samples were prepared and submitted to SGS-IPS testing for NWSP 160.1.R0 testing (i.e., Samples 5-12 to 5-19).

The test results for Samples 5-12 to 5-19 are provided in Table 15.

TABLE 15
Test Results (Samples 5-12 to 5-19)

| | | | | Gelbo Sum |
|---|---|---|---|---|
| | Absorbency | Absorptive | % Fiber | Value All Lint |
| Sample | Rate(s) | Capacity (g/g) | Loss | Classes |
| 5-12 | 3.0 | 14.4 | 15.9 | 17886 |
| 5-13 | 3.1 | 14.4 | 14.6 | 13705 |
| 5-14 | 1.4 | 13.8 | 12.8 | 422677 |
| 5-15 | 3.3 | 13.6 | 17.4 | 16904 |
| 5-16 | 1.6 | 11.9 | 16.7 | 467609 |
| 5-17 | 3.4 | 13.7 | Not measured | 5938 |
| 5-18 | 3.2 | 14 | Not measured | 7407 |
| 5-19 | 3.9 | 13.2 | Not measured | 15844 |

As provided in Table 15, Gelbo lint particle count measurements do not relate to % fiber loss measurements and in some instances were inverse of each other. These results indicate that reducing dusting from a sheet (or reducing fiber loss) and decreasing linting from a sheet can be accomplished by different mechanisms.

### Example 6: Low-Dust Airlaid Nonwovens—Silicone-Based Emulsion Testing (Post-Treatment) (Commercial Machine)

The present Example provides for testing of the application of silicone-based fluid emulsions as plasticizers to provide low-dust nonwoven materials. Such materials were tested after treatment with the plasticizer.

Sample Preparation

12-inch by 12-inch sheets of Georgia-Pacific Nonwovens LLC commercially produced latex bonded airlaid were obtained. The material included 88.2% Georgia Pacific Golden Isles® Semi-Treated Pulp Grade 4725 and was bonded together by 11.8% Wacker Chemie AG VINNAPAS® 192. The sample was formed in layers. Wacker E335 (35% actives) was diluted to 5% actives for. 0.5 to 2% total of the Wacker E335 was sprayed on each sheet as provided in Table 16. For other samples, either water or no spray at all were added to serve as controls for the study (i.e., Samples 6-6 to 6-11).

TABLE 16
Sample Preparation (Samples 6-1 to 6-11)

| | % Wacker E335 | % Water | Sides of | |
|---|---|---|---|---|
| | Actives addition | addition to sheet | Chemical | |
| Sample | to Sheet | (for control) | Application | Drying Method |
| 6-1 | 0.5 | 0 | 1 | Air dried |
| 6-2 | 1.0 | 0 | 2 | Air dried |
| 6-3 | 1.0 | 0 | 1 | Air dried |
| 6-4 | 2.0 | 0 | 2 | Air dried |
| 6-5 | 2.0 | 0 | 1 | Air dried |
| 6-6 | 0 | 0.5 | 1 | Air dried |
| 6-7 | 0 | 1.0 | 2 | Air dried |
| 6-8 | 0 | 1.0 | 1 | Air dried |
| 6-9 | 0 | 2.0 | 2 | Air dried |
| 6-10 | 0 | 2.0 | 1 | Air dried |
| 6-11 | 0 | 0 | none | Not applicable |

Testing

Samples 6-1 to 6-11 were tested for absorbency rate, absorptive capacity, and Gelbo Sum Value All Lint Classes as provided in Examples 4 and 5.

The test results are provided in Table 17.

TABLE 17
Test Results (Samples 6-1 to 6-11)

| | | | Gelbo Sum |
|---|---|---|---|
| | Absorbency | Absorptive | Value All Lint |
| Sample | Rate (s) | Capacity (g/g) | Classes |
| 6-1 | 2.78 | 8.94 | 4613 |
| 6-2 | 3.08 | 9.08 | 2856 |
| 6-3 | 3.66 | 9.29 | 3898 |
| 6-4 | 4.63 | 9.27 | 1680 |
| 6-5 | 3.79 | 8.73 | 1667 |
| 6-6 | 1.31 | 9.4 | 81985 |
| 6-7 | 1.29 | 8.91 | 77748 |
| 6-8 | 1.15 | 9.44 | 96628 |
| 6-9 | 1.39 | 9.54 | 63469 |
| 6-10 | 1.33 | 8.9 | 77565 |
| 6-11 | 1.16 | 8.85 | 90833 |

As provided in Table 17, as Wacker E335 addition levels increased, the absorbency rate and Gelbo sum lint values of the Samples decreased. Without being bound to a particular theory, decreasing the addition level of Wacker E335 can optimize both absorbency rate and Gelbo sum lint values.

### Example 7: Low-Dust Airlaid Nonwovens—Silicone-Based Emulsion Testing (Addition During Sample Production Process) (Pilot Plant)

The present Example provides for testing of the application of silicone-based fluid emulsions as plasticizers to provide low-dust nonwoven materials. Such materials were treated with a plasticizer during the material forming process.

A series of different samples of latex-bonded airlaid (LBAL) structures and multi-bonded airlaid (MBAL) structures were produced on a pilot line in three sample series. The samples were prepared and tested as provided below.

Sample Series 1 (Samples 7-1 to 7-8)

For the first set of samples, a 70 gsm LBAL, 61.8 gsm of Georgia Pacific Golden Isles® Semi-Treated Pulp Grade 4725 was formed in three layers on a Dan-Web airlaid machine at 30 meters/minute, utilizing an Albany ET100S forming wire. The samples were bonded by spraying 4.1 gsm binder application of Wacker Chemie AG VINNAPAS® 192 at 13.5% solids on each side and then dried in a through-air dryer at 170° C. All samples used 0.8% Cytec Solvay Group AEROSOL® OT 75 based upon binder solids.

Compaction of each sample was varied to target a starting caliper of 0.83 mm prior to any water or Wacker E335 treatment. The addition of water can decrease the caliper of airlaid materials and can result in increased bonding of fibers. Caliper could vary with sample treatment. Atmospheric humidity conditions can also contribute to this aspect for all three sets of samples produced.

Samples 7-1 to 7-8 were prepared as provided in Table 18. For samples containing Wacker E335 treatments, Wacker E335 (35% actives) was diluted to 5% actives. For some samples, the Wacker E335 and/or water was added after the binder was cured upon exiting the oven before the sample was rolled up. For other samples, the Wacker E335 and/or water was added before the binder was cured, either before or after the binder was sprayed through a separate spray bar. The Wacker E335 was not mixed with the binder due to known hydrophobicity concerns.

TABLE 18
Sample Preparation (Samples 7-1 to 7-8)

| | % Wacker | % Water | |
|---|---|---|---|
| | E335 | addition | |
| | Actives | to sheet | |
| Sample | addition | (for | |
| Number | to Sheet | control) | Location of Chemical Application |
| 7-1 | 0 | 0 | Not applicable |
| 7-2 | 0 | 1 | 1 side, top surface after binder cured |
| 7-3 | 1 | 0 | 1 side, top surface after binder cured |
| 7-4 | 0 | 1 | Both sides, after binder spray before curing |
| 7-5 | 0 | 2 | Both sides, after binder spray before curing |
| 7-6 | 1 | 0 | Both sides, after binder spray before curing |
| 7-7 | 2 | 0 | Both sides, after binder spray before curing |
| 7-8 | 2 | 0 | Both sides, before binder spray before |
| | | | curing |

Samples 7-1 to 7-8 were tested for absorbency rate, absorptive capacity, and Gelbo Sum Value All Lint Classes as provided in Examples 4 and 5.

The test results are provided in Table 19.

TABLE 19
Test Results (Samples 7-1 to 7-8)

| Sample | Caliper | Absorbency | Absorptive | Gelbo Sum Value |
|---|---|---|---|---|
| Number | (mm) | Rate (s) | Capacity (g/g) | All Lint Classes |
| 7-1 | 0.81 | 1.23 | 10.25 | 177688 |
| 7-2 | 0.51 | 1.30 | 8.55 | 102942 |
| 7-3 | 0.37 | 5.67 | 7.11 | 3088 |
| 7-4 | 0.70 | 1.39 | 10.42 | 132949 |
| 7-5 | 0.62 | 7.04 | 9.52 | 1282254 |
| 7-6 | 0.72 | 1.31 | 10.92 | 4864 |
| 7-7 | 0.62 | 5.00 | 9.21 | 4577 |
| 7-8 | 0.62 | 6.10 | 9.28 | 2728 |

For all LBAL samples, a minimum absorptive capacity of 6 g/g or 11 g/g is preferred and a maximum absorbency rate of 4 seconds or 2 seconds is preferred. A Gelbo sum value for all lint classes of less than about 48697 is preferred. Sample treatment may impact these values.

During absorptive capacity testing, samples treated on one side only with Wacker E335 after curing showed a slower absorbency rate for the treated side if it faced outward in the basket. Caliper was affected by the addition of liquid, whether water or dilute Wacker E335. Absorption times were slowed by the addition of Wacker E335 regardless of addition point although the addition of a lesser percent actives increased absorption times (e.g., Sample 7-6 versus Sample 7-7). Spraying Wacker E335 either before or after the binder, before curing, did not significantly impact absorption rate or absorptive capacity.

In all cases, water was shown to decrease linting. Without being bound to a particular theory, it is hypothesized that this can be due to bonding with the lower caliper substrate. In each case, the Wacker E335 linting value is much lower than the water value. Furthermore, it was observed that Wacker E335 linting value is much lower than the water value. Thus, caliper impact due to liquid addition alone is not the sole reason for Gelbo lint reduction from the addition of Wacker E335. The Wacker E335 actives addition amount can be decreased to a LBAL material to keep absorbency rate within desired limits while still maintaining a Gelbo Sum Lint Value below about 48697.

Sample Series 2 (Samples 7-9 to 7-13)

For the second set of samples, a 60 gsm MBAL, 40.9 gsm of Georgia Pacific Golden Isles® Semi-Treated Pulp Grade 4725 was mixed with 12.3 gsm Trevira T255 2641 2.2 dtex 6 mm fibers in three layers on a Dan-Web airlaid machine at 30 meters/minute, utilizing an Albany ET100S forming wire. The samples were bonded by spraying 3.6 gsm binder application of Wacker Chemie AG VINNAPAS® 192 at 13.5% solids on each side and then dried in a through-air dryer at 170° C. All samples used 0.8% Cytec Solvay Group AEROSOL® OT 75 based upon binder solids. Compaction of each sample was varied to target a starting caliper of 1.0 mm prior to any water or Wacker E335 treatment. Caliper was allowed to vary with sample treatment.

Samples 7-9 to 7-13 were prepared as provided in Table 20. For samples containing Wacker E335 treatments, Wacker E335 (35% actives) was diluted to 5% actives. For some samples, the Wacker E335 and/or water was added after the binder was cured upon exiting the oven before the sample was rolled up. For other samples, the Wacker E335 and/or water was added before the binder was cured, either before or after the binder was sprayed through a separate spray bar. The Wacker E335 was not mixed with the binder due to known hydrophobicity concerns.

TABLE 20
Sample Preparation (Samples 7-9 to 7-13)

| | % Wacker | % Water | |
|---|---|---|---|
| | E335 | addition | |
| | Actives | to sheet | |
| Sample | addition to | (for | Location |
| Number | Sheet | control) | of Chemical Application |
| 7-9 | 0 | 0 | Not applicable |
| 7-10 | 0 | 2 | Both sides, after binder spray |
| | | | before curing |
| 7-11 | 0 | 1 | 1 side, top surface after binder |
| | | | cured |
| 7-12 | 1 | 0 | 1 side, top surface after binder |
| | | | cured |
| 7-13 | 2 | 0 | Both sides, after binder spray |
| | | | before curing |

Samples 7-9 to 7-13 were tested for absorbency rate, absorptive capacity, and Gelbo Sum Value All Lint Classes as provided in Examples 4 and 5.

The test results are provided in Table 20.

TABLE 20
Test Results (Samples 7-9 to 7-13)

| Sample | | Absorbency | Absorptive | Gelbo Sum Value |
|---|---|---|---|---|
| Number | Caliper (mm) | Rate (s) | Capacity (g/g) | All Lint Classes |
| 7-9 | 0.90 | 1.45 | 12.00 | 23013 |
| 7-10 | 0.93 | 1.57 | 12.30 | 11911 |
| 7-11 | 0.63 | 1.59 | 10.59 | 13652 |
| 7-12 | 0.64 | 4.97 | 10.64 | 1368 |
| 7-13 | 0.90 | 14.42 | 10.98 | 601 |

For all MBAL samples, a minimum absorptive capacity of 8 g/g 10 g/g is preferred and a maximum absorbency rate of 5 seconds or below 2.5 seconds is preferred). A Gelbo sum value for all lint classes of less than about 48697 is preferred. Sample treatment may impact these values.

During absorptive capacity testing, samples treated on one side only with Wacker E335 after curing showed a slower absorbency rate for the treated side if it faced outward in the basket. Caliper was affected by the addition of liquid, whether water or dilute Wacker E335. Absorption times were slowed by the addition of Wacker E335 regardless of addition point although the addition of a lesser percent actives increased absorption times. Spraying the E335 either before or after the binder, before curing, did not significantly impact absorption rate or absorptive capacity. In all cases, water was shown to decrease linting. Without being bound to a particular theory, it is hypothesized that this can be due to bonding with the lower caliper substrate. In each case, the Wacker E335 linting value is much lower than the water value. Furthermore, it was observed that Wacker E335 linting value is much lower than the water value. Therefore it is clear that caliper impact due to liquid addition alone is not the sole driver to Gelbo lint reduction from the addition of Wacker E335. The Wacker E335 actives addition amount can be decreased to a MBAL material to keep absorbency rate within desired limits while still maintaining a Gelbo Sum Lint Value below about 48697.

Sample Series 3 (Samples 7-14 to 7-19)

For the third set of samples, a 70 gsm LBAL, 61.8 gsm of Georgia Pacific Golden Isles® Semi-Treated Pulp Grade 4725 was formed in three layers on a Dan-Web airlaid machine at 30 meters/minute, utilizing an Albany ET100S forming wire. The samples were bonded by spraying 4.1 gsm binder application of Celanese DUR-O-SET Elite 22 at 13.5% solids on each side and then dried in a through-air dryer at 170° C. Compaction of each sample was varied to target a starting caliper of 0.83 mm prior to any water or Wacker E33 5 treatment. Caliper can vary with sample treatment.

Samples 7-14 to 7-19 were prepared as provided in Table 22. For samples containing Wacker E335 treatments, Wacker E335 (35% actives) was diluted to 5% actives. For some samples, the Wacker E335 and/or water was added after the binder was cured upon exiting the oven before the sample was rolled up. For other samples, the Wacker E335 and/or water was added before the binder was cured, either before or after the binder was sprayed through a separate spray bar. The Wacker E335 was not mixed with the binder due to known hydrophobicity concerns.

TABLE 22
Sample Preparation (Samples 7-14 to 7-19)

| | % Wacker | | |
|---|---|---|---|
| | E335 | % Water | |
| | Actives | addition | |
| Sample | addition to | to sheet | |
| Number | Sheet | (for control) | Location of Chemical Application |
| 7-14 | 0 | 0 | Not applicable |
| 7-15 | 2 | 0 | Both sides, after binder spray before |
| | | | curing |
| 7-16 | 2 | 0 | Both sides, before binder spray before |
| | | | curing |
| 7-17 | 1 | 0 | 1 side, top surface after binder cured |
| 7-18 | 0 | 1 | 1 side, top surface after binder cured |
| 7-19 | 0 | 2 | Both sides, after binder spray before |
| | | | curing |

Samples 7-14 to 7-19 were tested for absorbency rate, absorptive capacity, and Gelbo Sum Value All Lint Classes as provided in Examples 4 and 5.

The test results are provided in Table 23.

TABLE 23
Test Results (Samples 7-14 to 7-19)

| Sample | | Absorbency | Absorptive | Gelbo Sum Value |
|---|---|---|---|---|
| Number | Caliper (mm) | Rate (s) | Capacity (g/g) | All Lint Classes |
| 7-14 | 0.68 | 1.61 | 9.47 | 69400 |
| 7-15 | 0.82 | 11.37 | 9.62 | 3173 |
| 7-16 | 0.77 | 9.83 | 9.95 | 2434 |
| 7-17 | 0.51 | 4.30 | 9.41 | 4728 |
| 7-18 | 0.57 | 1.82 | 9.87 | 69944 |
| 7-19 | 0.8 | 2.26 | 10.71 | 34068 |

For all LBAL samples, a minimum absorptive capacity of 6 g/g or 11 g/g is preferred and a maximum absorbency rate of 4 seconds or 2 seconds is preferred. A Gelbo sum value for all lint classes of less than about 48697 is preferred. Sample treatment may impact these values.

During absorptive capacity testing, samples treated on one side only with Wacker E335 after curing showed a slower absorbency rate for the treated side if it faced outward in the basket. Caliper was affected by the addition of liquid, whether water or dilute Wacker E335. Absorption times were slowed by the addition of Wacker E335 regardless of addition point although the addition of a lesser percent actives increased absorption times. Spraying Wacker E335 either before or after the binder, before curing, did not significantly impact absorption rate or absorptive capacity. In all cases, water was shown to decrease linting. Without being bound to a particular theory, it is hypothesized that this might be due to bonding with the lower caliper substrate. In each case, the Wacker E335 linting value is much lower than the water value. Furthermore, it was observed that Wacker E335 linting value is much lower than the water value. Therefore it is clear that caliper impact due to liquid addition alone is not the sole driver to Gelbo lint reduction from the addition of Wacker E335. The Wacker E335 actives addition amount can be decreased to a LBAL material to keep absorbency rate within desired limits while still maintaining a Gelbo Sum Lint Value below about 48697.

### Example 8: Low-Dust Airlaid Nonwovens—Treatment Samples Testing (Addition During Sample Production Process) (Pilot Plant)

The present Example provides for testing samples with varied compaction and amounts of Wacker E335 and/or water.

A series of different samples of latex-bonded airlaid (LBAL) structures were produced on a pilot line. 70 gsm LBAL, 61.8 gsm of Georgia Pacific Golden Isles® Semi-Treated Pulp Grade 4725 was formed in three layers on a Dan-Web airlaid machine at 30 meters/minute, utilizing an Albany ET100S forming wire. The samples were bonded by spraying 4.1 gsm binder application of Wacker Vinnapas 192 at 13.5% solids on each side and then dried in a through-air dryer at 170 degrees Celsius. All binder contained 0.8% Cytec Solvay Group AEROSOL® OT 75 based upon binder solids.

Compaction of each sample was varied to target a starting caliper of 0.83 mm prior to any water or Wacker E335 treatment. It was attempted to keep the caliper consistent.

For samples containing Wacker E335 treatments, Wacker E335 sold at 35% actives was diluted to 0.5 or 1.0% actives. For all samples, the Wacker E335 and/or water was added before the binder was cured, after the binder was sprayed through a separate spray bar. The Wacker E335 was not mixed with the binder due to known hydrophobicity issues.

For all LBAL samples the target absorptive capacity was at least 6 g/g and a maximum absorbency rate was at least 4 seconds. A Gelbo sum value for all lint classes of below 48697 was targeted.

Samples 8-1 to 8-7 were prepared as provided in Table 24.

TABLE 24
Sample Preparation (Samples 8-1 to 8-7)

| | % Wacker | | |
|---|---|---|---|
| | E335 | % Water | |
| | Actives | addition to | |
| Sample | addition to | sheet (for | |
| Number | Sheet | control) | Location of Chemical Application |
| 8-1 | 0 | 0 | Not applicable |
| 8-2 | 0.10 | 0 | Both sides, after binder spray before |
| | | | curing |
| 8-3 | 0.25 | 0 | Both sides, after binder spray before |
| | | | curing |
| 8-4 | 0.50 | 0 | Both sides, after binder spray before |
| | | | curing |
| 8-5 | 0.75 | 0 | Both sides, after binder spray before |
| | | | curing |
| 8-6 | 0 | 0.1 | Both sides, after binder spray before |
| | | | curing |
| 8-7 | 0 | 0.75 | Both sides, after binder spray before |
| | | | curing |

Samples 8-1 to 8-7 were tested for absorbency rate, absorptive capacity, and Gelbo Sum Value All Lint Classes as provided in Examples 4 and 5.

The test results are provided in Table 25.

TABLE 25
Test Results (Samples 8-1 to 8-7)

| | | | | Gelbo Sum |
|---|---|---|---|---|
| Sample | | Absorbency | Absorptive | Value All Lint |
| Number | Caliper (mm) | Rate (s) | Capacity (g/g) | Classes |
| 8-1 | 0.83 | 1.34 | 10.81 | 100841 |
| 8-2 | 0.82 | 3.00 | 11.12 | 34996.72 |
| 8-3 | 0.81 | 7.37 | 10.75 | 10288.52 |
| 8-4 | 0.81 | 11.84 | 10.69 | 10002.7 |
| 8-5 | 0.82 | 19.65 | 10.53 | 4001.28 |
| 8-6 | 0.81 | 1.29 | 10.81 | 74533.38 |
| 8-7 | 0.81 | 1.36 | 11.40 | 66269.78 |

Absorption times were slowed significantly by the addition of Wacker E335 regardless of addition amount although the addition of a lesser percent actives was helpful in minimizing this. In both cases, water decreased the linting. Without being bound by a particular theory, it is hypothesized that this can be due to better bonding with the lower caliper substrate. In each case, the Wacker E335 linting value is much lower than the water value. This means caliper impact due to liquid addition alone is not the sole reason for Gelbo lint reduction from the addition of Wacker E335. It appears merely decreasing the Wacker E335 actives amount is not enough to achieve an acceptable absorption rate in all cases.

### Example 9: Low-Dust Airlaid Nonwovens—Treatment Samples Testing (Addition During Sample Production Process) (Pilot Plant)

The present Example provides for testing samples with varied compaction and amounts of Wacker E335 and/or water.

A series of different samples of thermally-bonded airlaid (TBAL) structures were produced on a pilot line. 51.2 gsm TBAL was formed in three layers on a Dan-Web airlaid machine at 30 meters/minute, utilizing an Albany ET100S forming wire. The samples were bonded by drying in a through-air dryer at 160 degrees Celsius. The general structure of Samples 9-1 to 9-9 is shown in Table 26.

TABLE 26
Sample Structure (Samples 9-1 to 9-9)

| | |
|---|---|
| Raw Material | Basis Weight (gsm) |

Forming Head 3

| | |
|---|---|
| 2623 Trevira T-255 | 7.5 |
| Georgia Pacific Golden | 12.7 |
| Isles ® Semi-Treated Pulp | |
| Grade 4725 | |

Forming Head 2

| | |
|---|---|
| 2634 Trevira T-255 | 3.2 |
| Georgia Pacific Golden | 4.2 |
| Isles ® Semi-Treated Pulp | |
| Grade 4725 | |

Forming Head 1

| | |
|---|---|
| 2623 Trevira T-255 | 5.0 |
| Georgia Pacific Golden | 18.6 |
| Isles ® Semi-Treated Pulp | |
| Grade 4725 | |
| Total | 51.2 |

Compaction of each sample was varied to target a starting caliper of 1.0 mm prior to any water or Wacker E335 treatment. It was attempted to keep the caliper consistent.

For samples containing Wacker E335 treatments, Wacker E335 sold at 35% actives was diluted from 0.5 to 4.0% actives. For some samples, the Wacker E335 and/or water was added before the binder was cured, after the binder was sprayed through a separate spray bar. For other samples, the Wacker E335 was sprayed at the end of the line after the exit of the oven before the material was rolled up. The Wacker E335 was not mixed with the binder due to known hydrophobicity issues.

For all TBAL samples the target absorptive capacity was at least 8 g/g and a maximum absorbency rate was at least 5 seconds. A Gelbo sum value for all lint classes of below 48697 was targeted.

Samples 9-1 to 9-9 were prepared as provided in Table 27.

TABLE 27
Sample Preparation (Samples 9-1 to 9-9)

| | % Wacker | | |
|---|---|---|---|
| | E335 | % Water | |
| | Actives | addition to | |
| Sample | addition | sheet (for | |
| Number | to Sheet | control) | Location of Chemical Application |
| 9-1 | 0 | 0 | Not applicable |
| 9-2 | 0.1 | 0 | Both sides, after binder spray before |
| | | | curing |
| 9-3 | 0.5 | 0 | Both sides, after binder spray before |
| | | | curing |
| 9-4 | 1.0 | 0 | Both sides, after binder spray before |
| | | | curing |
| 9-5 | 0.1 | 0 | One side, top surface, after binder cured |
| 9-6 | 0.5 | 0 | One side, top surface, after binder cured |
| 9-7 | 1.0 | 0 | One side, top surface, after binder cured |
| 9-8 | 0 | 1.0 | Both sides, after binder spray before |
| | | | curing |
| 9-9 | 0 | 1.0 | One side, top surface, after binder cured |

Samples 9-1 to 9-9 were tested for absorbency rate, absorptive capacity, and Gelbo Sum Value All Lint Classes as provided in Examples 4 and 5.

The test results are provided in Table 28.

TABLE 28
Test Results (Samples 9-1 to 9-9)

| | | | Absorptive | Gelbo Sum | |
|---|---|---|---|---|---|
| Sample | Caliper | Absorbency | Capacity | Value All | % Fiber |
| Number | (mm) | Rate (s) | (g/g) | Lint Classes | Loss |
| 9-1 | 0.89 | 1.4 | 15.9 | 272274 | 1.8 |
| 9-2 | 0.9 | 2.9 | 14.4 | 70397 | 2.2 |
| 9-3 | 1.13 | 5.7 | 16.6 | 19161 | 1.5 |
| 9-4 | 1.15 | 5.7 | 18.0 | 3364 | 1.8 |
| 9-5 | 0.9 | 2.7 | 14.0 | 160436 | 1.8 |
| 9-6 | 0.92 | 4.4 | 13.4 | 98647 | 2.3 |
| 9-7 | 0.92 | 4.4 | 12.8 | 22018 | 2.0 |
| 9-8 | 0.91 | 1.7 | 15.9 | 23259 | 2.2 |
| 9-9 | 0.9 | 1.5 | 12.1 | 57017 | 1.9 |

It was observed that absorption times were slowed significantly by the addition of Wacker E335 regardless of addition amount although the addition of a lesser percent actives was helpful in minimizing this. It was also less impacted by one-sided end of line addition post curing. The absorbent capacity was negatively impacted by all post Wacker E335 or water additions. Gelbo Sum Values are better if the Wacker 335 is added to both sides. It appears merely decreasing the Wacker E335 actives amount is not enough to achieve an acceptable absorption rate in all instances.

### Example 10: Low-Dust Airlaid Nonwovens—Treatment Samples Testing with Varying Amounts of AEROSOL® OT 75 in the Binder (Addition During Sample Production Process) (Pilot Plant)

The present Example provides for testing samples with varied compaction and amounts of Wacker E335 and/or water, and varied amounts of Cytec Solvay Group AEROSOL® OT 75.

A series of different samples of latex-bonded airlaid (LBAL) structures were produced on a pilot line. 70 gsm LBAL, 61.8 gsm of Georgia Pacific Golden Isles® Semi-Treated Pulp Grade 4725 was formed in three layers on a Dan-Web airlaid machine at 30 meters/minute, utilizing an Albany ET100S forming wire. The samples were bonded by spraying 4.1 gsm binder application of Wacker Vinnapas 192 at 13.5% solids on each side and then dried in a through-air dryer at 170 degrees Celsius. All binder contained 0-1.6% Cytec Solvay Group AEROSOL® OT 75 based upon binder solids.

Compaction of each sample was varied to target a starting caliper of 0.83 mm prior to any water or Wacker E335 treatment. It was attempted to keep the caliper consistent.

For samples containing Wacker E335 treatments, Wacker E335 sold at 35% actives was diluted to 0.5 or 1.0% actives. For all samples, the Wacker E335 and/or water was added before the binder was cured, after the binder was sprayed through a separate spray bar. The Wacker E335 was not mixed with the binder due to known hydrophobicity issues.

For all LBAL samples the target absorptive capacity was at least 6 g/g and a maximum absorbency rate was at least 4 seconds. A Gelbo sum value for all lint classes of below 48697 was targeted.

Samples 10-1 to 10-10 were prepared as provided in Table 29.

TABLE 29
Sample Preparation (Samples 10-1 to 10-10)

| | % | | Aerosol | |
|---|---|---|---|---|
| | Wacker | % Water | OT | |
| | E335 | addition | Binder | |
| | Actives | to | Addition | |
| | addition | sheet | (Based on | |
| Sample | to | (for | Binder | Location of Chemical |
| Number | Sheet | control) | Solids) % | Application |
| 10-1 | 0 | 0 | 0.8 | Not applicable |
| 10-2 | 0.10 | 0 | 0.8 | Both sides, after binder |
| | | | | spray before curing |
| 10-3 | 0.15 | 0 | 0.8 | Both sides, after binder |
| | | | | spray before curing |
| 10-4 | 0.20 | 0 | 0.8 | Both sides, after binder |
| | | | | spray before curing |
| 10-5 | 0.25 | 0 | 0.8 | Both sides, after binder |
| | | | | spray before curing |
| 10-6 | 0 | 0.25 | 0.8 | Both sides, after binder |
| | | | | spray before curing |
| 10-7 | 0 | 0 | 0 | Both sides, after binder |
| | | | | spray before curing |
| 10-8 | 0.1 | 0 | 0 | Both sides, after binder |
| | | | | spray before curing |
| 10-9 | 0 | 0 | 1.6 | Both sides, after binder |
| | | | | spray before curing |
| 10-10 | 0.1 | 0 | 1.6 | Both sides, after binder |
| | | | | spray before curing |

Samples 10-1 to 10-10 were tested for absorbency rate, absorptive capacity, and Gelbo Sum Value All Lint Classes as provided in Examples 4 and 5.

The test results are provided in Table 30.

TABLE 30
Test Results (Samples 10-1 to 10-10)

| | | | | Gelbo Sum |
|---|---|---|---|---|
| Sample | | Absorbency | Absorptive | Value All Lint |
| Number | Caliper (mm) | Rate (s) | Capacity (g/g) | Classes |
| 10-1 | 0.66 | 1.4 | 10.3 | 64948 |
| 10-2 | 0.68 | 3.2 | 9.7 | 47178 |
| 10-3 | 0.68 | 4.5 | 9.5 | 19595 |
| 10-4 | 0.75 | 6.2 | 9.7 | 39125 |
| 10-5 | 0.78 | 8.0 | 10.0 | 9977 |
| 10-6 | 0.79 | 1.6 | 11.2 | 60980 |
| 10-7 | 0.79 | 2.0 | 10.8 | 70680 |
| 10-8 | 0.76 | 4.5 | 10.3 | 43030 |
| 10-9 | 0.75 | 1.1 | 10.2 | 95148 |
| 10-10 | 0.79 | 1.5 | 10.4 | 56263 |

It was observed that absorption times were slowed significantly by the addition of Wacker E335 regardless of addition amount although the addition of a lesser percent actives was helpful in minimizing this. The test results show that an increased addition of the surfactant AEROSOL® OT 75 to the binder helps in decreasing the absorbency rate back to an acceptable level. The disadvantage of adding additional AEROSOL®OT 75 to the binder is that it does negatively inhibit the Gelbo linting results. Sample 10-10 containing 0.1% Wacker E335 and a greater 1.6% addition of Aerosol OT 75 to the binder exceeds the target Gelbo sum value of under 48697.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

What is claimed is:

1. An airlaid nonwoven material comprising:
a first layer comprising cellulose fibers treated with a plasticizer,
wherein the nonwoven material has a dust content of less than about 10%.

2. The airlaid nonwoven material of claim 1, wherein the plasticizer comprises polyethylene glycol.

3. The airlaid nonwoven material of claim 2, wherein the plasticizer comprises polyethylene glycol 400.

4. The airlaid nonwoven material of claim 1, wherein the first layer further comprises a binder.

5. The airlaid nonwoven material of claim 1, further comprising a second layer adjacent to the first layer comprising bicomponent fibers.

6. The airlaid nonwoven material of claim 1, wherein the nonwoven material has an absorptive capacity of at least about 6 g/g.

7. The airlaid nonwoven material of claim 1, wherein the nonwoven material has an absorbency rate of less than about 10 seconds.

8. The airlaid nonwoven material of claim 1, wherein the nonwoven material has a Gelbo sum value of less than about 50000.

9. A multi-layer airlaid nonwoven material comprising:
a first layer comprising a first plasticizer;
a second layer adjacent to the first layer comprising cellulose fibers; and
a third layer adjacent to the second layer comprising a second plasticizer,
wherein the nonwoven material has a dust content of less than about 10%.

10. The multi-layer airlaid nonwoven material of claim 9, wherein the first and third layers further include a binder.

11. The multi-layer airlaid nonwoven material of claim 9, wherein the first and second plasticizers comprise polyethylene glycol.

12. The multi-layer airlaid nonwoven material of claim 11, wherein the first and second plasticizers comprise polyethylene glycol 400.

13. A multi-layer airlaid nonwoven material comprising:
a first layer comprising a plasticizer; and
a second layer adjacent to the first layer comprising cellulose fibers and a binder,
wherein the nonwoven material has a dust content of less than about 10%.

14. The multi-layer airlaid nonwoven material of claim 13, further comprising a third layer adjacent to the second layer comprising a plasticizer.

15. The multi-layer airlaid nonwoven material of claim 14, wherein the plasticizer of the first and third layers comprises polyethylene glycol.

16. The multi-layer airlaid nonwoven material of claim 13, wherein the plasticizer is present in an amount of from about 1% to about 2%, based on the total weight of the nonwoven material.
